(19) United States
(12) Patent Application Publication
(10) Pub. No.: US 2026/0236709 A1
(43) Pub. Date: Aug. 13, 2026

(54) Visual Description Representation Generation

(71) Applicant: GDM Holding LLC, Mountain View, CA (US)

(72) Inventors: Bryan Wesley Richter, Oakland, CA (US); Aaron Brandt Phillips, Mountain View, CA (US)

(21) Appl. No.: 19/048,351

(22) Filed: Feb. 7, 2025

(51) Int. Cl. G06F 40/40

(52) U.S. Cl. CPC G06F 40/40

(57) ABSTRACT

Systems and methods for visual description generation can obtain file data, generate a plurality of visual description outputs based on the file data, and process the plurality of visual description outputs for model training or model inference. The systems and methods can generate a representation with a generative agent model that interfaces with a plurality of tools for generating the plurality of visual description outputs.

### FIELD

The present disclosure relates generally to visual description generation. More particularly, the present disclosure relates to generating a representation descriptive of a plurality of different visual description outputs to be utilized for model training and/or model conditioning.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining, by a computing system including one or more processors, file data associated with a particular file. The particular file can include multimodal data. The method can include processing, by the computing system, the file data with a generative agent model to generate a plurality of different visual description outputs. The generative agent model can interface with a plurality of different data processing tools to generate the plurality of different visual description outputs. The method can include storing, by the computing system, the file data with the plurality of different visual description outputs. The method can include training, by the computing system, a vision language model on a training example including the file data and one or more of the plurality of different visual description outputs. In some implementations, training the vision language model can include training the vision language model to perform semantic understanding of the multimodal data via training the vision language model to generate an intermediate representation that is evaluated based on a comparison with the one or more of the plurality of different visual description outputs.

In some implementations, the plurality of different visual description outputs can include a hierarchical tree of semantic elements. The hierarchical tree of semantic elements can be descriptive of features depicted in the particular file. Processing, by the computing system, the generative agent model to generate the plurality of different visual description outputs can include processing, by the computing system, the file data with a first data processing tool to de-render an image from the particular file.

In some implementations, processing, by the computing system, the generative agent model to generate the plurality of different visual description outputs can include processing, by the computing system, the file data with an image annotation model to generate an annotated document. The annotated document can include a plurality of annotations rendered within the particular file.

In some implementations, processing, by the computing system, the generative agent model to generate the plurality of different visual description outputs can include processing, by the computing system, the file data with a second data processing tool to generate a second coding language output. The second coding language output can be descriptive of code for rendering the particular file. The second coding language output can differ from a coding language of the file data.

In some implementations, the plurality of different visual description outputs can include a first output that includes a list of elements depicted in the particular file, a second output that is descriptive of relative location information for a plurality of elements depicted in the particular file, and a third output that includes code for rendering the particular file. The plurality of different visual description outputs can include a scalable vector graphics output including a vector image format description of at least a subset of the particular file and a hypertext markup language format output including a hypertext markup language format description of the at least a subset of the particular file.

In some implementations, the particular file can include a plurality of slides. The particular file can include a document in a native document markup format. In some implementations, the vision language model can be trained to perform image captioning based on the file data and the plurality of different visual description outputs. In some implementations, the intermediate representation can include an organized hierarchical representation of the plurality of different visual description outputs in a natural language format that is configured to be processed with one or more prediction blocks of the vision language model to perform one or more downstream tasks. The intermediate representation can include visual description language that can then be processed to perform a downstream task. The downstream task can include at least one of image captioning, visual question and answering, image annotating, or other multimodal downstream tasks. The intermediate representation can include a hierarchical representation descriptive of different views and levels of granularity of visual description language.

Another example aspect of the present disclosure is directed to a computing system for multimodal document processing. The system can include one or more processors and one or more non-transitory computer-readable media that collectively store instructions that, when executed by the one or more processors, cause the computing system to perform operations. The operations can include obtaining a multimodal document. The multimodal document can include an image and structured text. The operations can include processing the multimodal document with a generative agent model to generate an aggregated dataset descriptive of a plurality of different visual description outputs. Generating the plurality of different visual description outputs can include processing the multimodal document to generate a first output descriptive of a list of a plurality of elements depicted in the multimodal document, processing the multimodal document to generate a second output including element relationship information descriptive model determined semantic relationships between the plurality of elements depicted in the multimodal document, and processing the multimodal document to generate a third output including code for recreating at least a portion of the multimodal document. The operations can include processing the aggregated dataset and a prompt with a generative language model to generate a model-generated output. The model-generated output can include a response generated based on the plurality of different visual description outputs. The operations can include providing the model-generated output for display.

In some implementations, the prompt can be descriptive of a request for a particular downstream task to be performed on the multimodal document. The particular downstream task can include document augmentation. The particular downstream task can include generating an output descriptive of a semantic understanding of the multimodal document. In some implementations, the first output can be generated with a first model. The second output can be generated with a second model. The third output can be generated with a third model. In some implementations, the first model, the second model, and the third model can be external to the generative agent model. The aggregated dataset can be generated by the generative agent model interfacing with each of the first model, the second model, and the third model. In some implementations, the generative agent model can include a transformer model communicatively connected with an application programming interface. The generative agent model can include multimodal encoders that encode text, images, and layouts of documents. Encoded data from the multimodal encoders can be processed with a planning block of the generative agent model to determine particular data processing tools to utilize and generate application programming interface calls that can be performed by the application programming interface. In some implementations, the generative agent model can include a reasoning block for processing the aggregated dataset to generate the aggregated dataset that include a hierarchical representation of the plurality of different visual description outputs. In some implementations, the plurality of different data processing tools can include at least one of a visual processing tool, a computer vision tool, an embedding based search engine, a document layout understanding model, a specialized diagnostics classification model, or other specialized model.

Another example aspect of the present disclosure is directed to one or more non-transitory computer-readable media that collectively store instructions that, when executed by one or more computing devices, cause the one or more computing devices to perform operations. The operations can include obtaining a particular file. The particular file can include an image and structured text. The operations can include processing the particular file with a generative agent model to generate an aggregated dataset descriptive of a plurality of different visual description outputs. The aggregated dataset can include a hierarchical tree of information associated with the particular file. In some implementations, the plurality of different visual description outputs can include a first description of a first level of granularity, a second description of a second level of granularity, and a third description descriptive of code for re-rendering the particular file. The operations can include processing at least a portion of the aggregated dataset and a prompt with a generative language model to generate a model-generated output. The prompt can include a query requesting information associated with the particular file. The model-generated output can include a response generated based on one or more of the plurality of different visual description outputs. The operations can include providing the model-generated output for display.

In some implementations, the model-generated output can include an annotated version of the particular file. The particular file can be annotated to indicate relevant portions of the particular file associated with the prompt. The model-generated output can include a structured format of information responsive to the query and comprising details from the plurality of different visual description outputs. In some implementations, the structured format can include image data, text data, and a diagram representation.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example multimodal processing system according to example embodiments of the present disclosure.

FIG. 2 depicts a block diagram of an example vision language model training system according to example embodiments of the present disclosure.

FIG. 3 depicts a flow chart diagram of an example method to perform vision language model training according to example embodiments of the present disclosure.

FIG. 4 depicts a block diagram of an example output generation and evaluation system according to example embodiments of the present disclosure.

FIG. 5A depicts an illustration of an example first portion of a description according to example embodiments of the present disclosure.

FIG. 5B depicts an illustration of an example second portion of a description according to example embodiments of the present disclosure.

FIG. 6 depicts an illustration of an example multimodal document according to example embodiments of the present disclosure.

FIG. 7 depicts a flow chart diagram of an example method to perform visual description condition model inference according to example embodiments of the present disclosure.

FIG. 8 depicts a flow chart diagram of an example method to perform multimodal prompt processing according to example embodiments of the present disclosure.

FIG. 9 depicts an illustration of an example element list for a multimodal document according to example embodiments of the present disclosure.

FIG. 10A depicts an illustration of an example first portion of an element list with locations according to example embodiments of the present disclosure.

FIG. 10B depicts an illustration of an example second portion of an element list with locations according to example embodiments of the present disclosure.

FIG. 10C depicts an illustration of an example third portion of an element list with locations according to example embodiments of the present disclosure.

FIG. 11 depicts an illustration of an example semantic determination according to example embodiments of the present disclosure.

FIG. 12A depicts a block diagram of an example computing system that performs visual description processing according to example embodiments of the present disclosure.

FIG. 12B depicts a block diagram of an example computing system that performs visual description processing according to example embodiments of the present disclosure.

FIG. 13 depicts a flow chart diagram illustrating an example method for training a machine-learned model according to example implementations of aspects of the present disclosure.

FIG. 14 depicts a block diagram of an example processing flow for using machine-learned model(s) to process input(s) to generate output(s) according to example implementations of aspects of the present disclosure.

FIG. 15 depicts a block diagram of an example sequence processing model according to example implementations of aspects of the present disclosure.

FIG. 16 depicts a block diagram of an example technique for populating an example input sequence for processing by a sequence processing model according to example implementations of aspects of the present disclosure.

FIG. 17 depicts a block diagram of an example model development platform according to example implementations of aspects of the present disclosure.

FIG. 18 depicts a block diagram of an example training workflow for training a machine-learned model according to example implementations of aspects of the present disclosure.

FIG. 19 depicts a block diagram of an inference system for operating one or more machine-learned model(s) to perform inference according to example implementations of aspects of the present disclosure.

FIG. 20 depicts a block diagram of an example networked computing system according to example implementations of aspects of the present disclosure.

FIG. 21 depicts a block diagram of an example computing device according to example implementations of aspects of the present disclosure.

FIG. 22 depicts a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for generating visual description language for model training, downstream tasks, and/or output evaluations. In particular, the systems and methods disclosed herein can be leveraged to generate an aggregation of a plurality of different visual description outputs that can be utilized to train, tune, and/or condition a generative model. For example, the systems and methods can obtain file data for a particular file (e.g., a document, a slide deck, a cell-based sheet or other tabular data format, web pages, a graphic such as an infographic, a chart, or similar, and/or other files). A generative agent model can process the file data to generate a plurality of visual description outputs. The plurality of visual description outputs can be generated with different data processing tools with which the generative agent model interfaces to generate the outputs. In some implementations, the plurality of visual description outputs can include feature lists (e.g., a list of objects and/or structures identified in the particular file), semantic relationship information (e.g., a description of the identified semantic relationships between different features within the particular file), code for rendering the particular file (which may differ from native code of the file data), and/or other visual description outputs. The resulting visual descriptions can be used for a number of different purposes. As an example, the plurality of visual description outputs can be leveraged to train a vision language model (e.g., to train a generative language model for image captioning and/or other image and/or multimodal processing tasks such as tool-free generation of visual description language outputs). Alternatively and/or additionally, the systems and methods may process a prompt and at least a portion of the plurality of visual description outputs with a generative model to perform a downstream task. The plurality of visual description outputs may include a visual description output that explicitly calls out features that are implicit in the document (e.g., a relationship between two or more elements (e.g., text and objects within an image)). The explicit callout of implicit features can improve model understanding of the image and/or document, which can improve downstream performance and may directly address at least a portion of a requested downstream task.

In some implementations, the systems and methods can generate a structured description of the content and layout in rich, multimodal documents that can be used as an interchange format. The structured description can constrain the space of outputs. A generated representation may be utilized to augment the structured description with one or more code formats for exact reproduction. The representation can include a simple and intuitive description, a hierarchical structure with variety in granularity and direction, a mix of descriptions of different types (e.g., natural language, image, code snippets, and/or structured data), data in multiple domains, and/or different output formats (e.g., pixel space, SVG, HTML, and/or AppScript) to be interpreted by and/or generated with a generative language model (e.g., a large language model).

The representation can include, be descriptive of, and/or may be utilized for aggregated visual description generation. The representation can be designed as an interchange format for an agent-based process to generate and revise multimodal documents. For example, the process may start with a single root element that provides a high-level description. Through dialogue with the user, an ideation agent may expand on the representation to add additional details such as child elements. The user may see an initial interpretation and may engage with the revision agent to “add a title centered at the top”. In the background, an evaluation agent may inspect interpretations and provide critiques to the revision agent on ways to improve the representation.

At a high-level, the aggregated data that includes a plurality of visual description outputs can include a tree of elements where each element is annotated with natural language, image, and/or code snippets. The elements in the tree may have a description. The descriptions can be paired with a representation and may include assets. The representation can be used to describe (in some form of code) part of a visual scene that can be rendered independently. An asset (e.g., an image, video, a set of text, and/or other asset from a file) may be used by representation.

For example, the systems and methods disclosed herein can generate an aggregated dataset of a plurality of different visual description outputs, which may include a hierarchical representation of visual description details. The hierarchical representation may include varying levels of detail and may include different code languages for describing and/or rendering a particular file. In some implementations, the hierarchical representation can include and/or be filtered to extract different views discussing different correlations and/or different descriptions of the environment. In some cases, the different views or “slices” of the data (e.g., which may correspond to certain branches and/or levels within the hierarchy; however, the views are not limited to such instances (e.g., a view can be a subset of information for each element but retaining the full tree of element)) may correspond to different axes of analysis or content description. As one example, two different views of the visual description language may respectively correspond to visual structure (e.g., a large object is prominent in the foreground) and visual content or style (e.g., the objects are shown in a colorful, cartoonish style). Other views may correspond to other axes of analysis or description.

The hierarchical representation can include details for understanding the placement of elements within the particular file (e.g., relative positioning of structured text, images, and/or other features). The hierarchical representation can include a structured representation (e.g., code and/or other structured representations) with unstructured natural language. The hierarchical representation may include assets and/or descriptions of assets and/or elements pulled from the particular file. The generation of the representation can provide for a detailed understanding of an input file (e.g., a particular document, a particular slide deck, a particular web page, and/or other file). The representation can be utilized to perform file augmentation, knowledge distillation for new content generation, visual question and answering, and/or other data processing tasks. The representation can be utilized to train a generative model for image captioning and/or intermediate representation generation. Alternatively and/or additionally, the visual description language generation may be performed as preprocessing for a generative model to then process with a given prompt for model inference.

The detailed, extensive visual description language can be utilized to grow the quantity and quality of training data for different image and/or multimodal data processing tasks. The growth of the training data can be utilized to reduce model generalization, tune a model for more detailed data processing tasks, and/or mitigate biases. As one example, training data (e.g., training pairs or other training examples) can be generated by filtering the visual description language for a particular item to extract certain views or subsets of the visual description language. Different training tasks can then be established in which a model undergoing training is supplied with some extracted views and is tasked with producing other, withheld portions of the visual description language or the underlying data file itself, or vice versa.

Additionally and/or alternatively, the detailed, extensive visual description language can be utilized for conditioning the response generation to a prompt (or query). The visual description language generation can be utilized for preprocessing for machine-learned models that may struggle with image and/or multimodal data processing. Therefore, a benefit of the systems and methods disclosed herein may include generating a variety of visual description outputs in which one or more of the visual description outputs may explicitly call out semantic relationships depicted with images and/or documents that are implicit in their native format.

In some implementations, the use of the visual description language as a conditioning input can be limited to using some view, slice, or other subset of the visual description language as a conditioning input. For example, a user may seek to create a new generative output that contains some, but not all of the visual characteristics of an existing file. For example, a user may seek to create a new infographic that has the same visual structure as an existing infographic but which has a different visual style. The portion of the visual description language associated with the visual structure (but not the visual style) of the existing infographic can be extracted as used as a conditioning input for one or more generative model processes performed to generate the new infographic. As a result, the new infographic may have a similar visual structure to the existing infographic but may have a different visual style.

In particular, some machine learned models, including some generative models, can struggle with image processing. The struggles can translate to multimodal processing, which may include document understanding tasks. The systems and methods disclosed herein can generate and/or aggregate visual description outputs that can be leveraged to train, fine-tune, and/or condition these models, which can improve the performance of these models on image and/or multimodal processing tasks.

In more detail, some example systems and methods can include obtaining file data associated with a particular file and/or data descriptive of the particular file. The particular file can include image data and/or multimodal data. The multimodal data can include structured text adjacent to images, diagrams, videos, and/or audio file elements. The particular file can include a plurality of slides. The plurality of slides can include text data, image data, latent encoding data, structure data, sequence data, and/or multimodal data. In some implementations, the particular file can include a document in a native document markup format. The systems and methods may include obtaining a multimodal document. The multimodal document can include an image and structured text. The structured text may have varying character sizes, various stylizations, various paragraphs, various structures, and/or various relationships with other text, images, and/or other data.

The computing system can include processing the file data with a generative agent model to generate a plurality of different visual description outputs. The generative agent model can interface with a plurality of different data processing tools to generate the plurality of different visual description outputs. The plurality of different visual description outputs can include a hierarchical tree of semantic elements. The hierarchical tree of semantic elements can be descriptive of features depicted in the particular file. In some implementations, the systems and methods can include processing the multimodal document with a generative agent model to generate an aggregated dataset descriptive of a plurality of different visual description outputs. The generative agent model can include an autoregressive language model tuned, trained, and/or configured to interface with different external data processing tools. The generative agent model can be configured to generate application processing interface calls for interfacing with the different external tools. In some implementations, the plurality of different visual description outputs can be generated without the use of a generative agent model. For example, the systems and methods may process the file data with the plurality of different data processing tools to generate the plurality of different visual description outputs. The use of the plurality of different data processing tools may be performed based on procedural code.

In some implementations, the plurality of different visual description outputs can include a first output that includes a list of elements depicted in the particular file, a second output that is descriptive of relative location information for a plurality of elements depicted in the particular file, and a third output that includes code for rendering the particular file. The elements can include images, structured text elements (e.g., headers, body paragraphs, captions, sub-headers, footnotes, and/or other structured text elements), videos, diagrams, and/or other elements. The code can be the native code for the particular file and/or may be a second coding language that differs from the native code for the particular file. Additionally and/or alternatively, the plurality of different visual description outputs can include a scalable vector graphics output that includes a vector image format description of at least a subset of the particular file and a hypertext markup language format output that includes a hypertext markup language format description of the at least a subset of the particular file.

In some implementations, processing the generative agent model to generate the plurality of different visual description outputs can include processing the file data with a first data processing tool to de-render an image from the particular file. De-rendering the image from the particular file can include generating rendering code and/or a vector representation of the image. The de-rendering may include processing the image with one or more machine-learned models. The first data processing tool may include an encoder model, an embedding model, an image-to-code model, and/or other model.

In some implementations, processing the generative agent model to generate the plurality of different visual description outputs can include processing the file data with a second data processing tool to generate a second coding language output. The second coding language output can be descriptive of code for rendering the particular file. The second coding language output can differ from a coding language of the file data. In some implementations, the plurality of different visual description outputs may include a plurality of different coding languages that describe the elements of the particular file.

Additionally and/or alternatively, processing the generative agent model to generate the plurality of different visual description outputs can include processing the file data with an annotation model (e.g., an image annotation model) to generate an annotated document. The annotated document can include a plurality of annotations rendered within the particular file. The annotations can be descriptive of semantic labels for the particular file. The semantic labels can be descriptive of element correlations, element labels, and/or asset descriptions.

In some implementations, generating the plurality of different visual description outputs can include processing the multimodal document to generate a first output descriptive of a list of a plurality of elements depicted in the multimodal document, processing the multimodal document to generate a second output including element relationship information descriptive model determined semantic relationships between the plurality of elements depicted in the multimodal document, and processing the multimodal document to generate a third output including code for recreating at least a portion of the multimodal document. The first output can be generated with a first model. In some implementations, the second output can be generated with a second model. The third output can be generated with a third model. The first model, the second model, and the third model can be external to the generative agent model. The aggregated dataset can be generated by the generative agent model interfacing with each of the first model, the second model, and the third model.

The generative agent model may generate an aggregated dataset based on the plurality of different visual description outputs. The aggregated dataset can include a hierarchical representation (e.g., a hierarchical tree) of information associated with the particular file. The plurality of different visual description outputs can include a first description of a first level of granularity, a second description of a second level of granularity, and a third description descriptive of code for re-rendering the particular file. Additionally and/or alternatively, the plurality of different visual description outputs can be descriptive of different views and/or different aspects of the particular file.

The systems and methods may leverage the plurality of different visual description outputs and/or the aggregated dataset to perform a downstream task with a generative model and/or may leverage the plurality of different visual description outputs and/or the aggregated dataset to train a generative model. The generative model may include a generative language model (e.g., a large language model and/or a vision language model). In some implementations, the systems and methods may leverage the plurality of different visual description outputs and/or the aggregated dataset to perform a downstream task and/or to evaluate the outputs of an image captioning model. The downstream task may include visual question and answering, image captioning, document augmentation, content item generation, and/or other tasks.

The systems and methods can include processing the aggregated dataset and a prompt with a generative language model to generate a model-generated output. The model-generated output can include a response generated based on the plurality of different visual description outputs. The systems and methods can include providing the model-generated output for display. In some implementations, the prompt can be descriptive of a request for a particular downstream task to be performed on the multimodal document. The particular downstream task can include document augmentation. The particular downstream task can include generating an output descriptive of a semantic understanding of the multimodal document. In some implementations, the systems and methods can include processing the aggregated dataset and a prompt with a generative language model to generate a model-generated output. The prompt can include a query requesting information associated with the particular file. The model-generated output may include a response generated based on the plurality of different visual description outputs.

In some implementations, the model-generated output can include an annotated version of the particular file. The particular file can be annotated to indicate relevant portions of the particular file associated with the prompt. In some implementations, the model-generated output can include a structured format of information responsive to the query and can include details from the plurality of different visual description outputs. The structured format can include image data, text data, and a diagram representation.

The systems and methods can include storing the file data with the plurality of different visual description outputs. The systems and methods can include training a vision language model on a training example including the file data and the plurality of different visual description outputs. Training the vision language model can include training the vision language model to perform semantic understanding of the multimodal data via training the vision language model to generate an intermediate representation that is evaluated based on a comparison with the plurality of different visual description outputs. The vision language model can be trained to perform image captioning based on the file data and the plurality of different visual description outputs. The training may utilize one or more loss functions, which can be utilized to generate a gradient descent for tuning parameters of the generative model to generate a representation similar to the representation of the aggregated dataset. For example, training the vision language model can include obtaining a training dataset that includes a plurality of training examples in which each training example includes a multimodal document and a target output. The target output can include a representation descriptive of a plurality of visual descriptions of the multimodal document. The vision language model can process the multimodal document to generate a prediction output. A loss function can then be evaluated based on comparing the target output and the prediction output. A gradient descent can be generated based on the loss function evaluation. One or more parameters of the vision language model can then be adjusted based on the gradient descent. In particular, the gradient descent can adjust the parameters of the vision language model to condition the model to generate prediction outputs that emulate the target output when processing the multimodal document.

The systems and methods of the present disclosure provide a number of technical effects and benefits. As one example, the system and methods can generate a representation descriptive of a plurality of visual description outputs that can then be leveraged for model training, generative model processing, and/or model output evaluations. In particular, the systems and methods can leverage a generative agent model to understand a document and/or other files that may include image data.

Another technical benefit of the systems and methods of the present disclosure is the ability to leverage a plurality of visual description outputs that can be detailed and extensive, which can improve generative model training and/or conditioning. In particular, the systems and methods can generate a hierarchical representation that includes different coding languages, different levels of granularity, and/or different descriptive views and/or purposes. By generating the extensive visual descriptive language, the training and/or tuning of generative models can be improved by growing the training data size and can mitigate generalizations and/or biases caused by smaller and simpler datasets. In some implementations, the systems and methods described herein can improve the precision and/or recall of the vision language model on a plurality of different downstream tasks by training the vision language model to generate a more robust visual description representation of processed multimodal documents that can then be leveraged by the vision language model to perform the particular downstream task. For example, the precision of visual question and answering can be improved as the vision language model has been trained to generate a representation descriptive of visual description language that covers a variety of different points of view and levels of granularity. In some implementations, the systems and methods disclosed herein can reduce the number of steps and/or compute time of the model inference by leveraging the representation generation process to reduce the computational cost and timing of multiple inference loops (e.g., multiple reasoning and planning steps with multiple external tool calls at different instances) to identify the relevant information as the representation is descriptive of a robust and extensive hierarchical coverage of visual descriptions of the input file.

Another example of technical effect and benefit relates to improved computational efficiency and improvements in the functioning of a computing system. For example, the systems and methods disclosed herein can leverage the aggregated visual description outputs to condition a pre-trained generative model for image and/or multimodal processing tasks without the computational cost of re-training the model.

With reference now to the Figures, example embodiments of the present disclosure will be discussed in further detail.

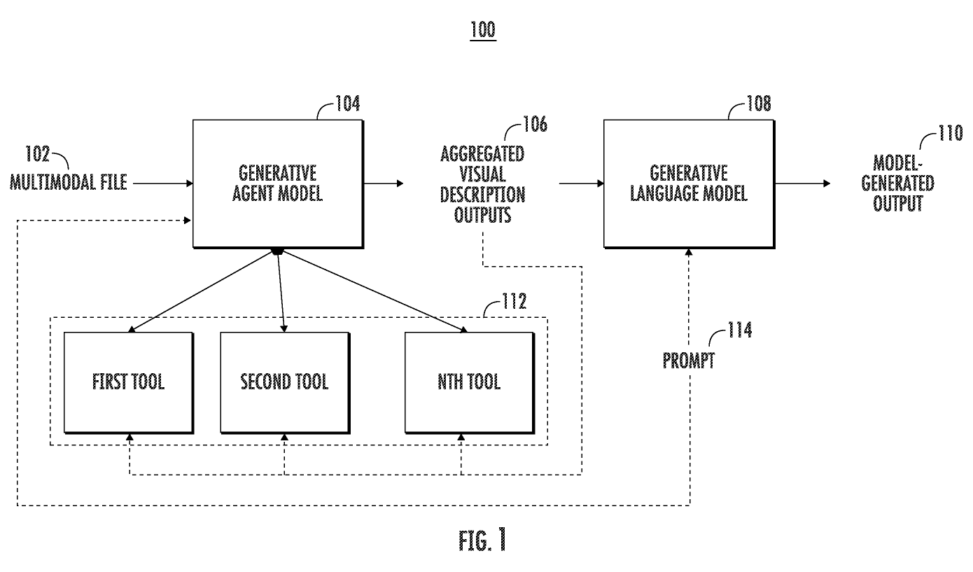

FIG. 1 depicts a block diagram of an example multimodal processing system 100 according to example embodiments of the present disclosure. In some implementations, the multimodal processing system 100 is configured to receive, and/or obtain, multimodal file 102 descriptive of a multimodal document and, as a result of receipt of the multimodal file 102, generate, determine, and/or provide a model-generated output 110 that is descriptive of a semantic representation of the multimodal file and/or a response to a prompt 114. Thus, in some implementations, the multimodal processing system 100 can include a generative agent model 104 that is operable to generate and/or aggregate a plurality of visual description outputs generated based on interfacing with a plurality of tools 112.

In particular, the multimodal processing system 100 can obtain a multimodal file 102 (e.g., a particular file with multimodal data). The multimodal file 102 may be obtained via an upload interface, a link interface, and/or an application programming interface. The multimodal file 102 can include a particular file that includes multimodal data, which may include one or more images and one or more structured text blocks. For example, the multimodal file can include a document that has a header for the title, a sub-header, multiple body paragraphs, images interweaved with the multiple body paragraphs, and captions for the images. The different structured text blocks and images can have varying relationships with one another with regards to the semantics of the document.

A generative agent model 104 can process the multimodal file 102 (e.g., the file data) to generate an aggregated dataset 106 that includes and/or is descriptive of a plurality of visual description outputs. The generative agent model 104 can include a foundational model configured, trained, and/or tuned for orchestrating the processing of input data with one or more external tools. The generative agent model 104 can include a large language model (e.g., a large autoregressive language model). In some implementations, the generative agent model can embed the input data and then perform sequence predictions based on the embeddings and/or the tokens. The aggregated dataset 106 can include a hierarchical representation that includes different perspectives and/or different levels of granularity of visual descriptions. The plurality of visual description outputs can be generated with a plurality of data processing tools 112. The plurality of data processing tools 112 may include an embedding model, an encoder model, a classification model, an object recognition model, a detection model, a file-to-code model, a code-to-code translation model, a computer vision model, and/or other tools. For example, the plurality of data processing tools 112 can include Document AI (“Document AI,” Google Cloud (Jan. 9, 2025), https://cloud.google.com/document-ai/docs.), Google Cloud’s Vertex AI (“Cloud Vision API,” Google Cloud (last viewed Jan. 12, 2025), https://cloud.google.com/vision?hl=en.), Imagen (“Imagen 3,” Google DeepMind (Dec. 21, 2024), https://deepmind.google/technologies/imagen-3/.), Cloud Vision API (“Cloud Vision API,” Google Cloud (last viewed Jan. 12, 2025), and/or other tools. The generative agent model 104 can interface with the plurality of tools via application programming interfaces via the generation and execution of application programming interface calls. In some implementations, the plurality of data processing tools 112 can be stored in one or more tool libraries that can be communicatively connected with nodes of the generative agent model 104 to provide for a synthetic classification head extension.

A generative language model 108 can process the aggregated dataset 106 and/or the multimodal file 102 to generate a model-generated output 110. The model-generated output 110 can include a structured output, which may include details and/or assets from the multimodal file 102. The model-generated output 110 may include a distillation of knowledge from the plurality of visual description outputs and/or a representation of information from the plurality of visual description outputs. In some implementations, the model-generated output 110 may include an augmented version of the multimodal file 102.

The generative language model 108 (e.g., a large language model) can be trained, tuned, and/or configured to perform one or more downstream tasks. In some implementations, the generative language model may include an autoregressive language model.

In some implementations, the generative language model 108 may process the prompt 114 and the aggregated dataset 106 to generate the model-generated output 110. The prompt may be 114 a hard prompt (e.g., a user input prompt that includes texts and/or image) and/or a soft prompt (e.g., a set of tuned parameters that can be interpreted by the generative language model 108 to condition the model’s predictions). The prompt 114 may be obtained from a user via a user interface and/or may be obtained from a prompt library based on the multimodal file 102 and/or a user request. The prompt 114 may be descriptive of a particular task to perform and/or a particular query associated with requesting information about the multimodal file 102. The model-generated output 110 can be responsive to the prompt 114 and include and/or be based on details associated with the multimodal file 102.

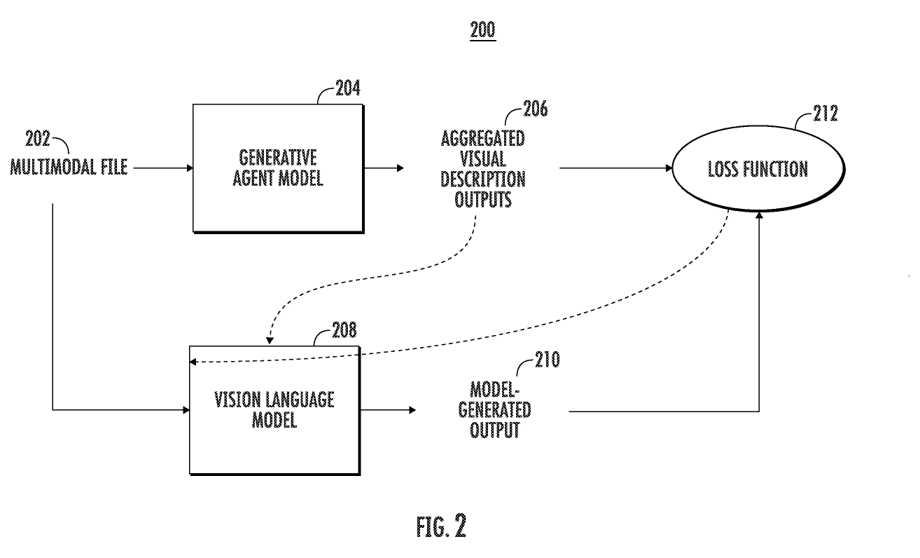

FIG. 2 depicts a block diagram of an example vision language model training system 200 according to example embodiments of the present disclosure. The vision language model training system 200 is similar to the multimodal processing system 100 of FIG. 1 except that vision language model training system 200 further includes a training loop that leverages a loss function 212.

In particular, the vision language model training system 200 can obtain a multimodal file 202 (e.g., an academic paper, a spreadsheet, a slideshow, a web page, a homework assignment, a book, a video, a portfolio review, and/or other file). The multimodal file 202 may be obtained via an upload interface, a link interface (e.g., an input box for inputting a link associated with the multimodal file 202), and/or an application programming interface. The multimodal file 202 can include a particular file that includes multimodal data (e.g., a web page that includes images of a particular bird along with several paragraphs discussing details associated with the birds), which may include one or more images and one or more structured text blocks. For example, the multimodal file can include a document, slide deck, and/or web page that has a header for the title, a sub-header, multiple body paragraphs, images interweaved with the multiple body paragraphs, and captions for the images. The different structured text blocks and images can have varying relationships with one another with regards to the semantics of the document.

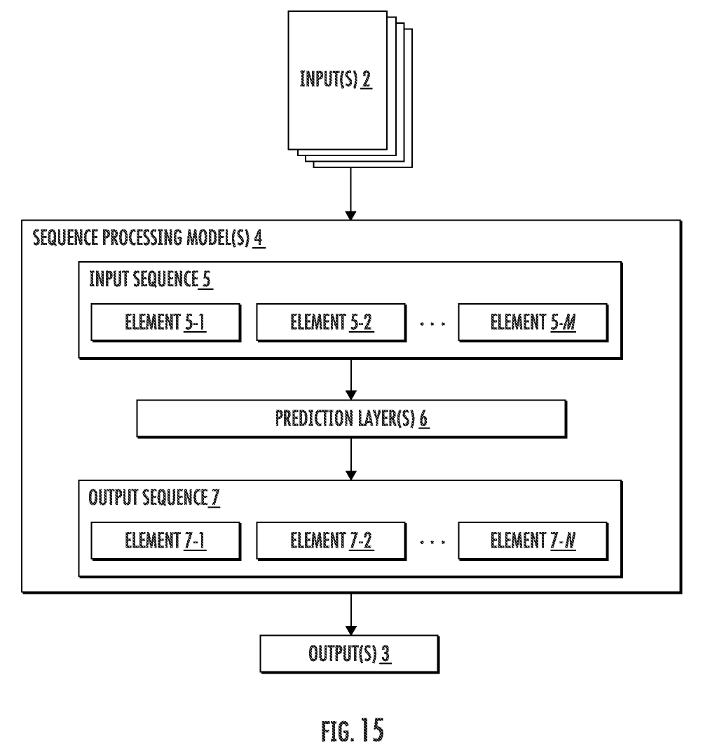

A generative agent model 204 can process the multimodal file 202 (e.g., the file data) to generate an aggregated dataset 206 that includes and/or is descriptive of a plurality of visual description outputs. The generative agent model 204 can include a foundational model configured, trained, and/or tuned for orchestrating the processing of input data with one or more external tools. The generative agent model 204 can include a large language model (e.g., a large autoregressive language model). The generative agent model 204 can include one or more transformer models and may be trained, tuned, and/or configured for sequence-to-sequence predictions (e.g., as discussed in connection with FIG. 15). The generative agent model 204 can include a Gemini model (“Gemini: A Family of Highly Capable Multimodal Models,” arXiv (Jun. 17, 2024), https://arxiv.org/pdf/2312.11805.) or other pre-trained generative model tuned and/or configured for agent tasks (e.g., AVIS (Hu et al., “AVIS: Autonomous Visual Information Seeking with Large Language Model Agent,” arXiv (Nov. 2, 2023), https://arxiv.org/pdf/2306.08129.) and/or memory-and-planning configurations (Park et al., “Generative Agents: Interactive Simulacra of Human Behavior,” Google Research (2023), https://research.google/pubs/generative-agents-interactive-simulacra-of-human-behavior/.). In some implementations, the generative agent model can embed the input data and then perform sequence predictions based on the embeddings and/or the tokens. The aggregated dataset 206 can include a hierarchical representation that includes different perspectives and/or different levels of granularity of visual descriptions. The plurality of visual description outputs can be generated with a plurality of data processing tools. The plurality of data processing tools may include an embedding model, an encoder model, a classification model, an object recognition model, a detection model, a file-to-code model, a code-to-code translation model, a computer vision model, and/or other tools.

The multimodal file 202 and the aggregated dataset 206 can then be utilized as a training example for training and/or tuning a machine-learned model. For example, the vision language model training system 200 can generate a plurality of training examples that can then be stored in a training dataset. The training dataset can then be utilized to train the machine-learned model.

In particular, the vision language model training system 200 can utilize a vision language model 208 to process the multimodal file 202 to generate a model-generated output 210. A loss function 212 can then be evaluated based on a comparison between the aggregated dataset 206 and the model-generated output 210. The evaluation of the loss function 212 can be utilized to generate a gradient descent that is backpropagated to the vision language model 208 to adjust one or more parameters of the vision language model 208. The loss function 212 may include an L2 loss, a perceptual loss, a realism loss, a triplet loss, and/or other loss term. The loss function 212 can be configured to penalize model-generated outputs 210 that deviate from a structure and/or contents of the aggregated dataset 206. For example, the vision language model training system 200 can be configured to train and/or tune the vision language model 208 to generate intermediate representations (e.g., a representation of an aggregation of a plurality of different visual descriptions of the multimodal file 202 that can be leveraged for reference for performing downstream tasks) and/or model-generated outputs 210 (e.g., natural language outputs of individualized visual descriptions that may be based on and/or included within the intermediate representation) that emulate the visual description language generation of the generative agent model 204. The intermediate representations and/or the model-generated outputs can be compared to the aggregated visual description outputs 206 to evaluate the loss function 212 and generate a gradient descent that can be backpropagated to the vision language model to tune one or more parameters of the vision language model 208 to reduce one or more losses. For example, the loss function 212 may include penalization terms associated with deviations from the aggregated visual description outputs 206 (e.g., penalizing missing levels of granularity, missing perspectives, and/or deviations from the object/semantic identifications). The vision language model 208 can be trained for image captioning tasks, image understanding tasks, multimodal augmentation tasks, and/or other data processing tasks.

The vision language model 208 can include a text encoder, an image encoder, a structural encoder, a decoder, and/or other processing blocks. The vision language model 208 can be trained and/or tuned for performing a plurality of different downstream tasks.

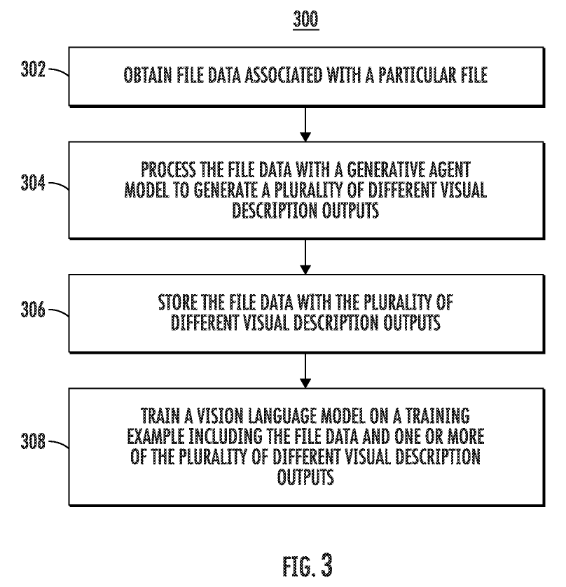

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain file data associated with a particular file. The file data may include raw file data. The particular file can include multimodal data. In some implementations, the particular file can include a plurality of slides. The particular file can include a document in a native document markup format. The particular file can include a document, a plurality of data cells, a slide deck, a graphic (e.g., an infographic, a chart, or similar), a web page, and/or other file. The multimodal data can include text data, image data, video data, audio data, latent encoding data, and/or other data.

At 304, the computing system can process the file data with a generative agent model to generate a plurality of different visual description outputs. The generative agent model can interface with a plurality of different data processing tools to generate the plurality of different visual description outputs. The plurality of different visual description outputs can include a hierarchical tree of semantic elements. The hierarchical tree of semantic elements can be descriptive of features depicted in the particular file. In some implementations, the plurality of different visual description outputs can include a first output that includes a list of elements depicted in the particular file, a second output can be descriptive of relative location information for a plurality of elements depicted in the particular file, and a third output that includes code for rendering the particular file. Alternatively and/or additionally, the plurality of different visual description outputs can include a scalable vector graphics output including a vector image format description of at least a subset of the particular file and a hypertext markup language format output including a hypertext markup language format description of the at least a subset of the particular file. The resulting visual descriptions can be used for a number of different purposes.

In some implementations, processing the file data with the generative agent model to generate the plurality of different visual description outputs can include processing the file data with a first data processing tool to de-render an image from the particular file. The first data processing tool may include an encoder model, an embedding model, an image-to-code model, and/or other models. The image de-rendering can include generating a vector representation of the image and/or generate code descriptive of the image.

In some implementations, processing the file data with the generative agent model to generate the plurality of different visual description outputs can include processing the file data with an image annotation model to generate an annotated document. The annotated document can include a plurality of annotations rendered within the particular file. The annotated document can include bounding boxes, labels, highlights, arrows, and/or other annotations. The bounding boxes may be descriptive of identifications of different elements within the particular file. The labels can be descriptive of element labels, relationship labels, content topic labels, and/or other labels.

In some implementations, processing the generative agent model to generate the plurality of different visual description outputs can include processing the file data with a second data processing tool to generate a second coding language output. The second coding language output can be descriptive of code for rendering the particular file. The second coding language output can differ from a coding language of the file data. In some implementations, the plurality of different visual description outputs may include a plurality of different coding languages.

At 306, the computing system can store the file data with the plurality of different visual description outputs. The file data and the plurality of different visual description outputs can be indexed as a training example within a training dataset. The training example can be stored with a plurality of other training examples generated with the generative agent model.

At 308, the computing system can train a vision language model on a training example including the file data and one or more of the plurality of different visual description outputs. Training the vision language model can include training the vision language model to perform semantic understanding of the multimodal data via training the vision language model to generate an intermediate representation that is evaluated based on a comparison with the one or more of the plurality of different visual description outputs. The loss function can include one or more losses for evaluating differences between the intermediate representation and the one or more of the plurality of different visual description outputs in order to generate a gradient descent that can be backpropagated to the vision language model to reduce the losses on future inferences. The vision language model can be trained to perform image captioning based on the file data and the plurality of different visual description outputs. Training may include processing the file data with the vision language model to generate a model-generated output, evaluating a loss function based on a comparison between the model-generated output and the plurality of different visual description outputs, and adjusting one or more parameters of the vision language model based on the loss function.

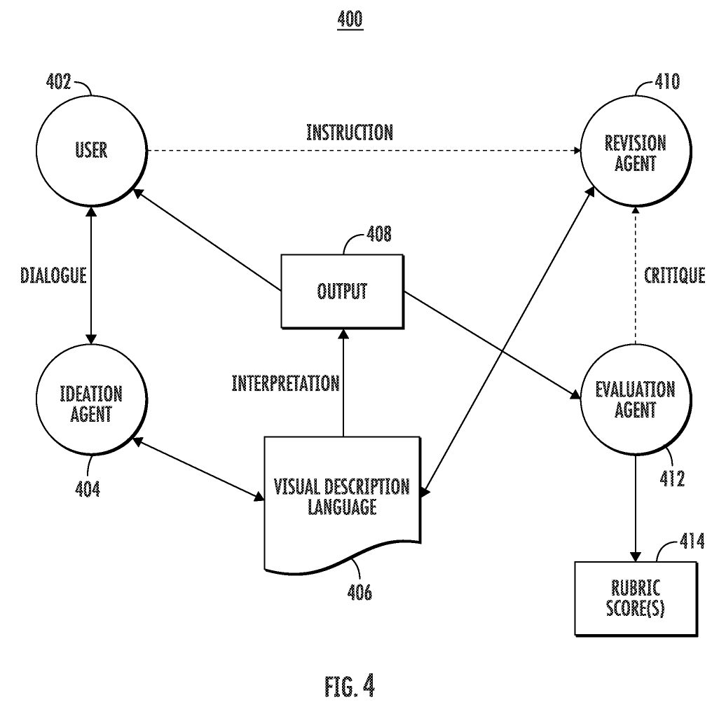

FIG. 4 depicts a block diagram of an example output generation and evaluation system 400 according to example embodiments of the present disclosure. In particular, the output generation and evaluation system 400 including a generative agent model can obtain file data, dialogue, and instructions from a user computing device 402. The input data can be processed with one or more blocks of the generative agent model to generate visual description language 406 that can then be interpreted to generate the model output 408 (e.g., a hierarchical representation that includes details from the visual description language 406).

In some implementations, one or more agents of the generative agent model can be leveraged to evaluate, augment, and/or adjust the visual description language 406 and/or the model output 408. For example, an ideation agent block 404 can process the dialogue to condition and/or adjust the visual description language. Additionally and/or alternatively, a revision agent block 410 can process the instructions to condition and/or adjust the visual description language 406. In some implementations, the revision agent may process critique data generated with an evaluation agent block 412 that processes the model output 408 to identify features that are to be adjusted or removed. In some implementations, the evaluation agent block 412 may determine and/or leverage one or more rubric scores 414.

Additionally and/or alternatively, the user computing device 402 may receive the model-output 408 for display. In some implementations, the user computing device may interface with one or more agent blocks to augment the visual description language 406 and/or the model output 408.

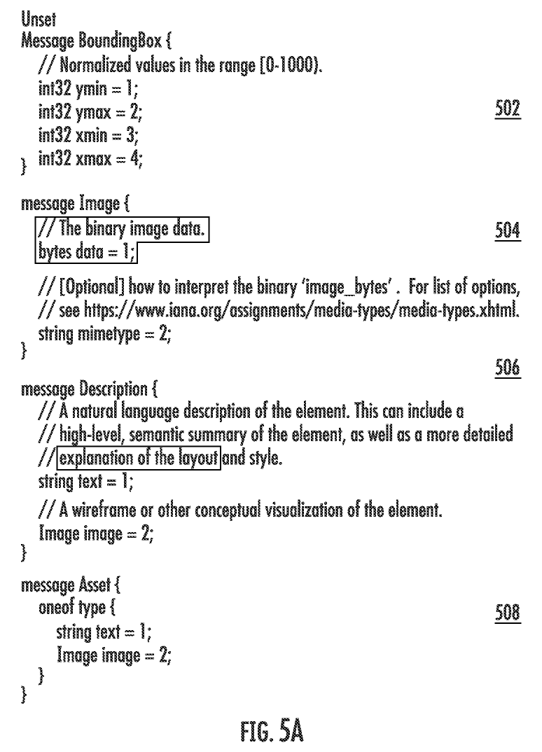

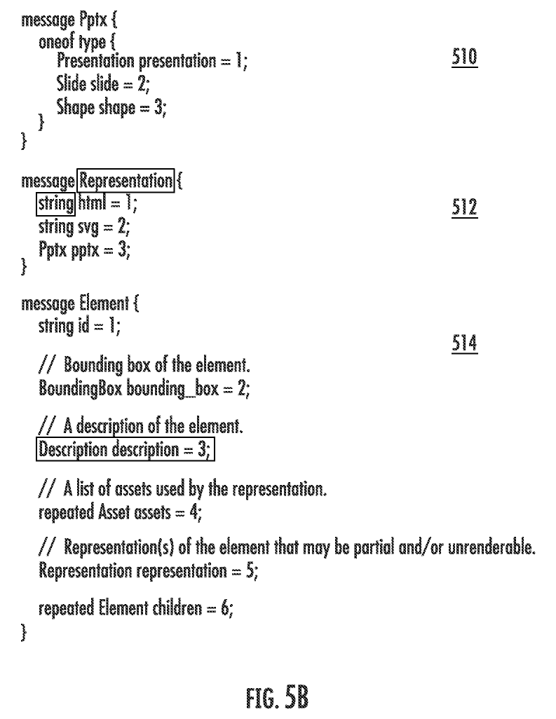

FIG. 5A depicts an illustration of an example first portion of a description according to example embodiments of the present disclosure. In particular, FIG. 5A depicts a description for a file with the description having detection details and individualized element details. For example, the description includes a list of detected element positions 502. The list of detected element positions 502 is descriptive of the positions of a plurality of bounding boxes associated with the positions of detected elements including images, text blocks, and other elements. The description includes a plurality of individualized descriptions, which includes an image description 504, a text string description 506, and a multimodal asset description 508.

FIG. 5B depicts an illustration of an example second portion of a description according to example embodiments of the present disclosure. In particular, FIG. 5B depicts a continuation of the description of FIG. 5A. For example, the description can further include slide details 510 for the file, code-based representations 512, and a summary of the different visual description outputs/types 514 within the description.

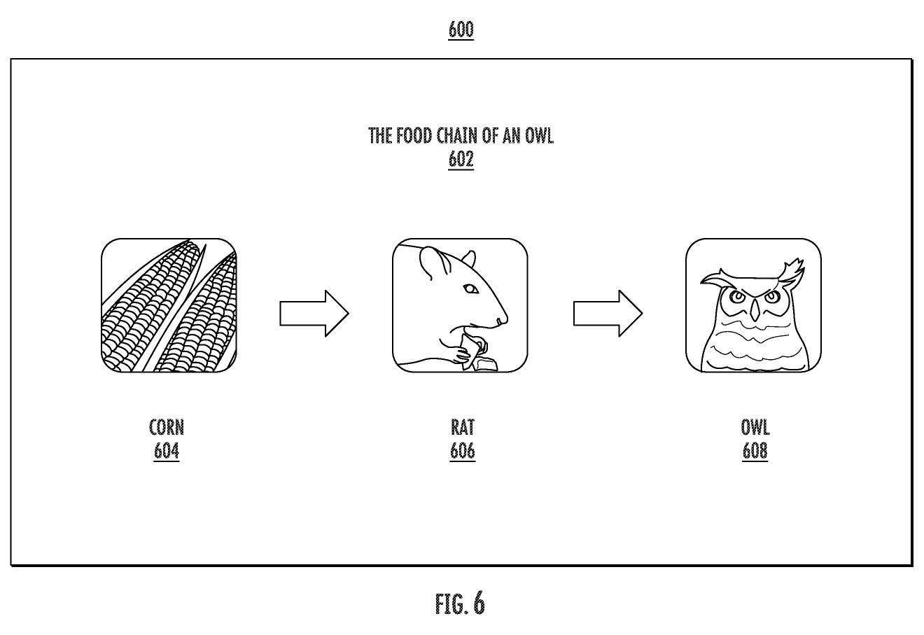

FIG. 6 depicts an illustration of an example multimodal document 600 according to example embodiments of the present disclosure. In particular, the systems and methods disclosed herein can process a file descriptive of the multimodal document 600 to generate an aggregated dataset of visual description outputs that can be leveraged to generate a model-generated output. For example, the multimodal document 600 (e.g., a multimodal graphic) may be obtained from a web page, research paper, slide deck, and/or other file that describes animal ecosystems, food chains, and/or general owl information. The multimodal document may include a title 602, a first image 604, a second image 606, and a third image 608, a text caption for each of the images, and/or one or more diagram features (e.g., arrows). The different text strings may have different sizes, fonts, kerning, and/or other differing style features. The systems and methods disclosed herein may process the particular file to generate the model-generated output based on a prompt requesting a natural language response to a question, a graphic be generated based on an open-ended semantic distillation task, and/or other task.

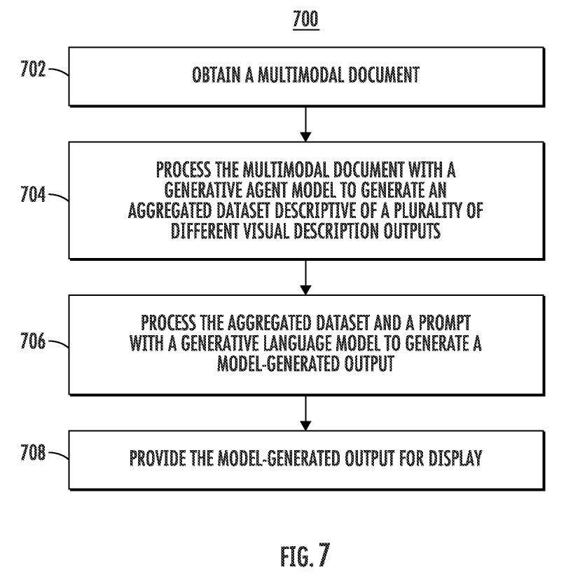

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain a multimodal document. The multimodal document can include an image and structured text. The multimodal document can include the image adjacent to different sets of structured text. Different portions of the structured text may have different relationships with the image and/or other portions of the structured text. In some implementations, the multimodal document may be obtained with and/or based on obtaining a prompt. The prompt may be descriptive of a request to perform a particular task based on the contents of the multimodal document.

At 704, the computing system can process the multimodal document with a generative agent model to generate an aggregated dataset descriptive of a plurality of different visual description outputs. Generating the plurality of different visual description outputs can include processing the multimodal document to generate a first output descriptive of a list of a plurality of elements depicted in the multimodal document, processing the multimodal document to generate a second output including element relationship information descriptive model determined semantic relationships between the plurality of elements depicted in the multimodal document, and processing the multimodal document to generate a third output including code for recreating at least a portion of the multimodal document. In some implementations, the first output can be generated with a first model. The second output can be generated with a second model. The third output can be generated with a third model. In some implementations, the first model, the second model, and the third model can be external to the generative agent model. The aggregated dataset can be generated by the generative agent model interfacing with each of the first model, the second model, and the third model. In some implementations, the generative agent model may process the multimodal document and the prompt to generate the aggregated dataset descriptive of a plurality of different visual description outputs.

At 706, the computing system can process the aggregated dataset and a prompt with a generative language model to generate a model-generated output. The model-generated output can include a response generated based on the plurality of different visual description outputs. In some implementations, the prompt can be descriptive of a request for a particular downstream task to be performed on the multimodal document. The particular downstream task can include document augmentation. Alternatively and/or additionally, the particular downstream task can include generating an output descriptive of a semantic understanding of the multimodal document. The prompt may be obtained from a user computing system. The prompt may include a hard prompt and/or a soft prompt. The prompt may include text data, image data, audio data, latent encoding data, parameter weights, and/or other data.

At 708, the computing system can provide the model-generated output for display. The model-generated output may be provided for display in a graphical user interface. The model-generated output may be provided for display within a search results interface, an augmented-reality interface, a virtual assistant interface, and/or other interface. The model-generated output may include a graphical representation, a text string, an augmented image, a synthetic image, and/or other data.

In some implementations, the computing system may invoke the various steps of the method 700 based on the user providing a prompt. For example, the computing system may obtain a prompt provided by a user computing system associated with a user. The computing system may process the prompt and the multimodal document (which may be fetched based on the prompt) with the generative agent model to generate an aggregated dataset of the plurality of different visual description outputs. The aggregated dataset may include a visual description representation that includes a hierarchical representation of the plurality of different visual description outputs. The computing system can then generate and provide a model-generated output.

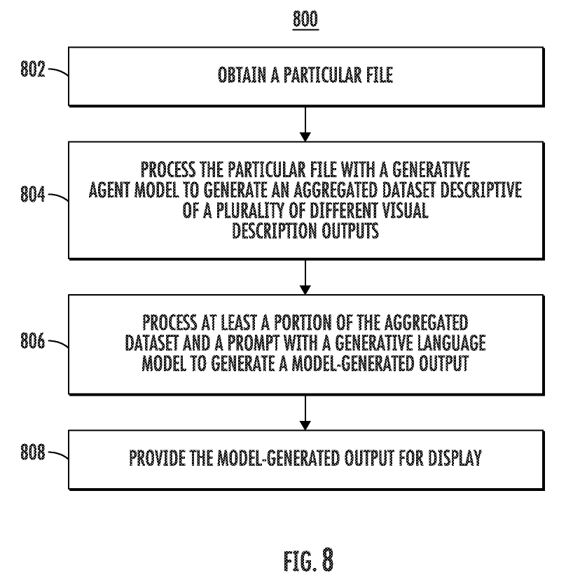

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a particular file. The particular file can include an image and structured text. In some implementations, the particular file can include a plurality of slides. The particular file can include a document in a native document markup format. The particular file can include a document, a plurality of data cells, a slide deck, a graphic, a web page, and/or other file. The multimodal data can include text data, image data, video data, audio data, latent encoding data, and/or other data.

At 804, the computing system can process the particular file with a generative agent model to generate an aggregated dataset descriptive of a plurality of different visual description outputs. The aggregated dataset can include a hierarchical tree of information associated with the particular file. The plurality of different visual description outputs can include a first description of a first level of granularity, a second description of a second level of granularity, and a third description descriptive of code for re-rendering the particular file.

At 806, the computing system can process at least a portion of the aggregated dataset and a prompt with a generative language model to generate a model-generated output. The prompt can include a query requesting information associated with the particular file. The model-generated output can include a response generated based on one or more of the plurality of different visual description outputs. In some implementations, the model-generated output can include an annotated version of the particular file. The particular file can be annotated to indicate relevant portions of the particular file associated with the prompt. The model-generated output can include a structured format of information responsive to the query. The model-generated output can include details from the plurality of different visual description outputs. In some implementations, the structured format can include image data, text data, and a diagram representation.

At 808, the computing system can provide the model-generated output for display. The model-generated output may be provided for display in a graphical user interface. The model-generated output may be provided for display within a search results interface, an augmented-reality interface, a virtual assistant interface, and/or other interface. The model-generated output may include a graphical representation, a text string, an augmented image, a synthetic image, and/or other data.

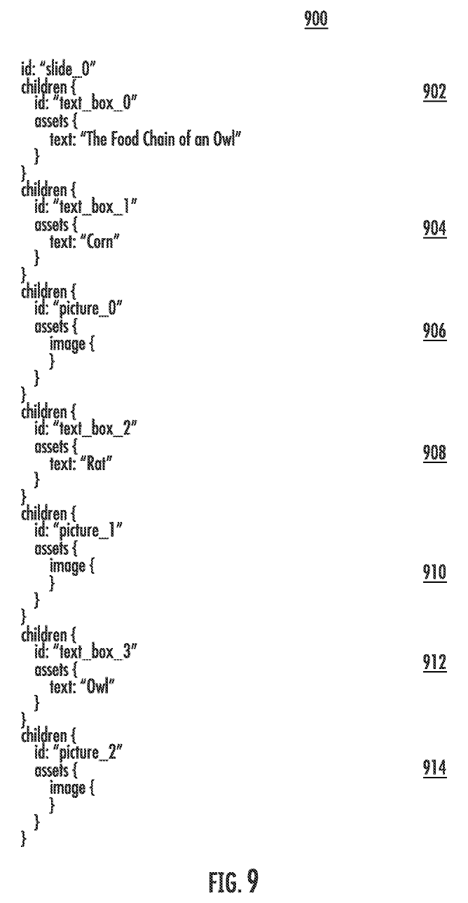

FIG. 9 depicts an illustration of an example element list for a multimodal document 900 according to example embodiments of the present disclosure. In particular, in some implementations, the particular file may include a slide deck and/or other document. The visual description representations may include slide by slide descriptions and/or a full slide deck description. In some implementations, the visual description representation may include a description breakdown of a graphic. The element list 900 depicted in FIG. 9 includes a description for the multimodal document 600 of FIG. 6. The description includes details for a first text box 902, a second text box 904, a first picture 906, a third text box 908, a second picture 910, a fourth text box 912, and a third picture 914.

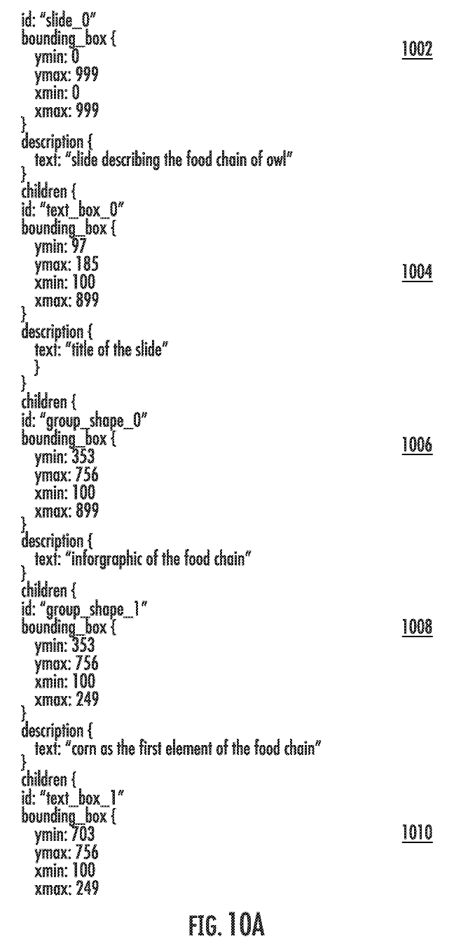

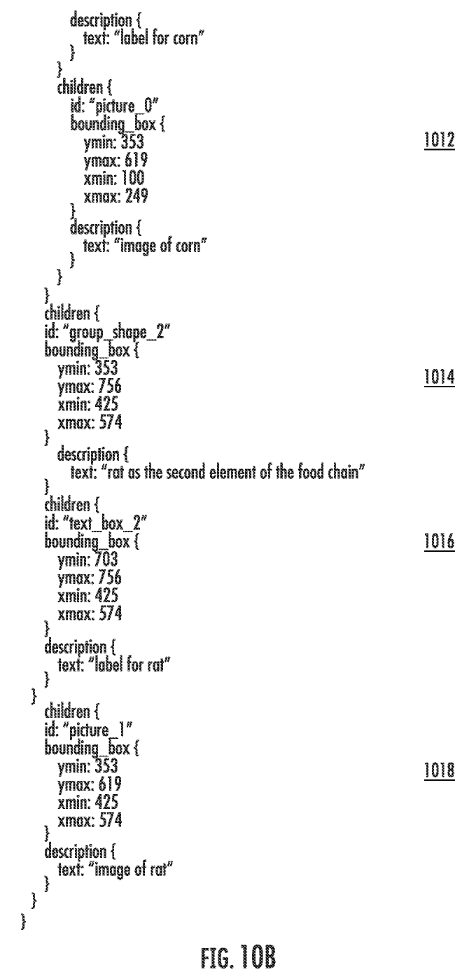

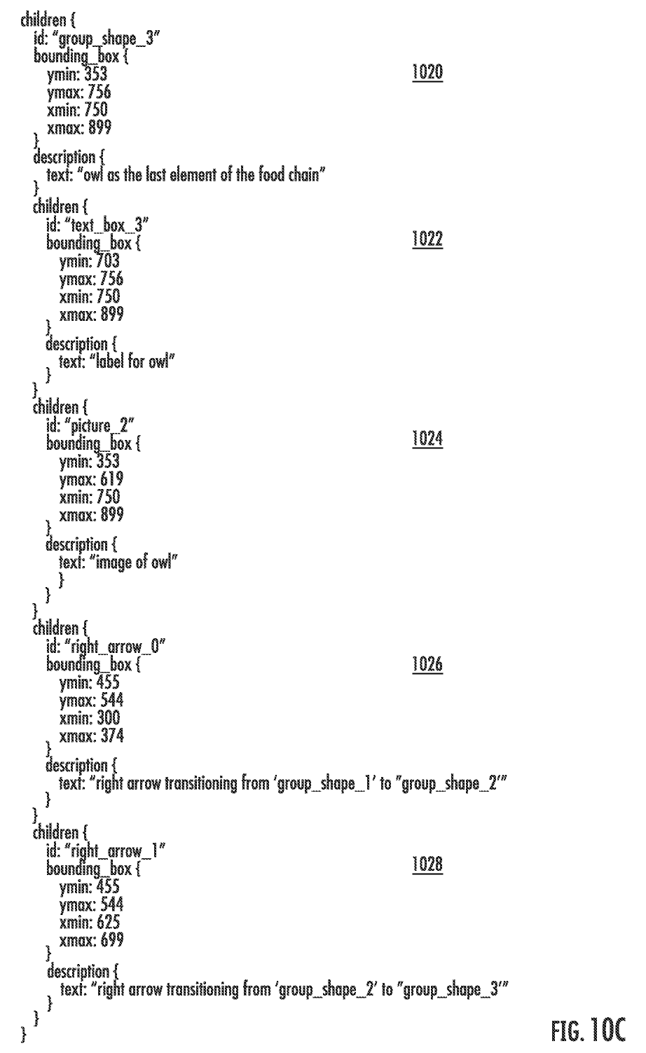

FIG. 10A depicts an illustration of an example first portion of an element list with locations according to example embodiments of the present disclosure. The element list can begin with slide identification details 1002 for the slide that includes the elements described in the following lines. The element list can include a first text description 1004 describing the position of the respective first text and a semantic label for the respective first text. The element list can include a first shape description 1006 describing the position of the respective first shape (e.g., a first graphic) and a semantic label for the respective first shape. In some implementations, the element list can include a second shape description 1008 describing the position of the respective second shape (e.g., a second graphic) and a semantic label for the respective second shape. The element list can include a second text description 1010 describing the position of the respective second text and a semantic label for the respective second text.

FIG. 10B depicts an illustration of an example second portion of an element list with locations according to example embodiments of the present disclosure. In particular, the element list can include a first image description 1012 describing the position of the respective first image and a semantic label for the respective first image. The element list can include a third shape description 1014 describing the position of the respective third shape (e.g., a third graphic) and a semantic label for the respective third shape. In some implementations, the element list can include a third text description 1016 describing the position of the respective third text and a semantic label for the respective third text. The element list can include a second image description 1018 describing the position of the respective second image and a semantic label for the respective second image.

FIG. 10C depicts an illustration of an example third portion of an element list with locations according to example embodiments of the present disclosure. In particular, the element list can include a fourth shape description 1020 describing the position of the respective fourth shape (e.g., a fourth graphic) and a semantic label for the respective fourth shape. The element list can include a fourth text description 1022 describing the position of the respective fourth text and a semantic label for the respective fourth text. In some implementations, the element list can include a third image description 1024 describing the position of the respective third image and a semantic label for the respective third image. Additionally and/or alternatively, the element list can include a first arrow description 1026 and a second arrow description 1028 descriptive of positions and semantic labels for arrows within the particular file.

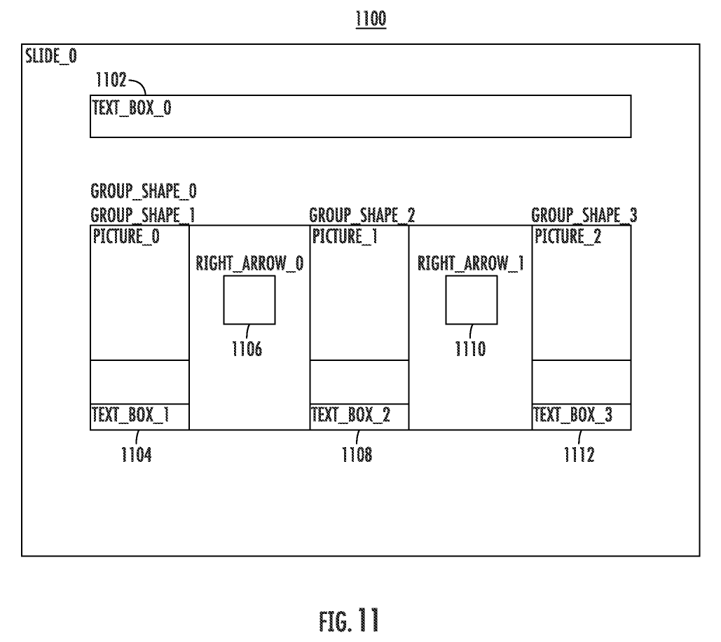

FIG. 11 depicts an illustration of an example semantic determination 1100 according to example embodiments of the present disclosure. In particular, FIG. 11 depicts a plurality of bounding boxes and semantic labels associated with elements of a slide or graphic. For example, a first bounding box and label can be associated with a title text box 1102. A second bounding box and label can be associated with a first multimodal element box 1104. A third bounding box and label can be associated with a second multimodal element box 1108. A fourth bounding box and label can be associated with a third multimodal element box 1112. In some implementations, the fifth bounding box and label and the sixth bounding box and label can be associated with a first arrow element 1106 and a second arrow element 1110.

The systems and methods described herein can be utilized for annotating multi-modal documents with the objective of improving inference, training, and evaluation of LLMs.

A multi-modal document can generally include some code (e.g. SVG) that can be rendered into a raster image. Visual description language (e.g., the aggregated dataset) can include over-complete representations that enable additional “views” of this data while also preserving the original format.

The visual description language (e.g., the aggregated dataset) can include a tree of elements where each element can include: the location of each element in the render, a description with natural language or images, and one or more types of code (e.g. PPTX, SVG, HTML) that can render the element.

The elements can be meant to represent semantically-meaningful units and be organized hierarchically to teach LLMs how to plan the document. From this representation, the systems and methods can extract and generate additional views, such as: a high-level plan of the elements required to compose the document, a wireframe of the layout of elements in the document, and a translation between different code representations for the same element(s).

These different views can facilitate the performance of LLM tasks that teach specific capabilities, such as: given a render, generate the plan of elements; given a plan of elements, generate elements with code representation; and given one or more element(s), translate between different code representations.

Furthermore, these different views can facilitate step-wise inference and evaluation of specific capabilities.

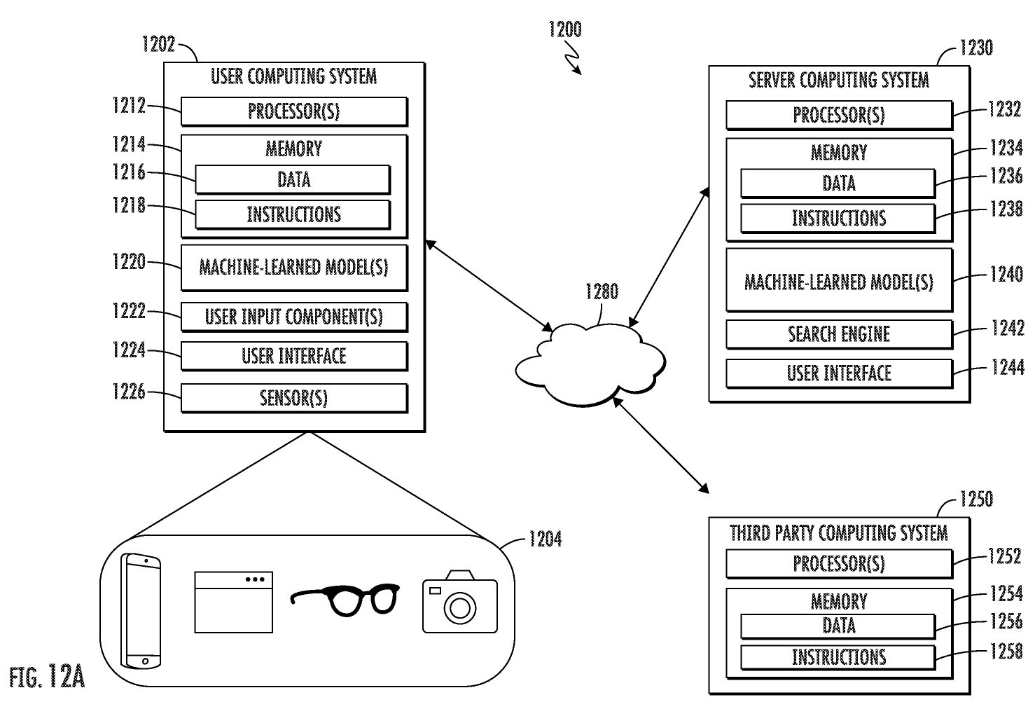

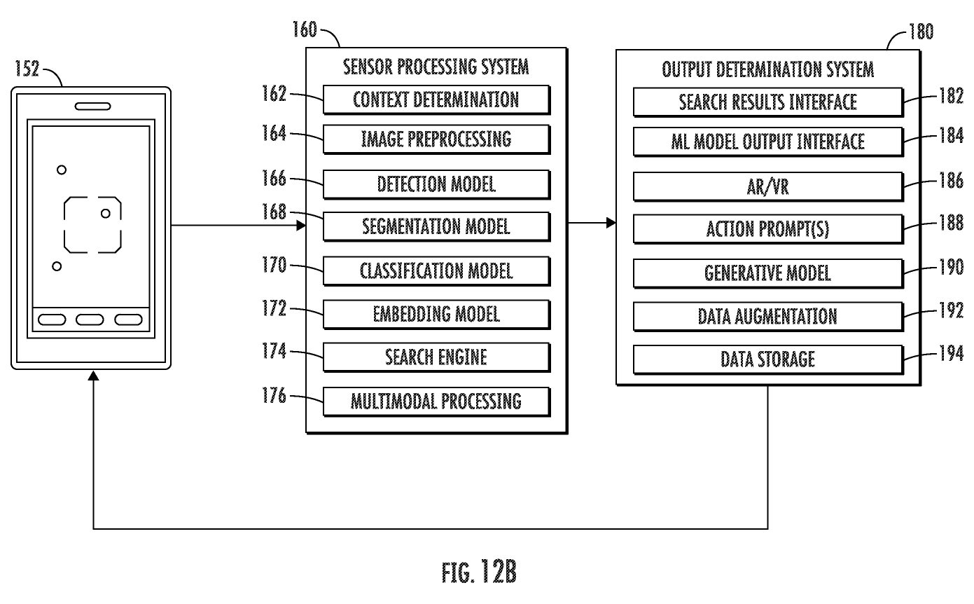

FIG. 12A depicts a block diagram of an example computing system 1200 that performs visual description processing according to example embodiments of the present disclosure. The system 1200 includes a user computing system 1202, a server computing system 1230, and/or a third party computing system 1250 that are communicatively coupled over a network 1280.

The user computing system 1202 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 1202 includes one or more processors 1212 and a memory 1214. The one or more processors 1212 can be any suitable processing device (e.g., a processor core, a microprocessor, an ASIC, a FPGA, a controller, a microcontroller, etc.) and can be one processor or a plurality of processors that are operatively connected. The memory 1214 can include one or more non-transitory computer-readable storage mediums, such as RAM, ROM, EEPROM, EPROM, flash memory devices, magnetic disks, etc., and combinations thereof. The memory 1214 can store data 1216 and instructions 1218 which are executed by the processor 1212 to cause the user computing system 1202 to perform operations.

In some implementations, the user computing system 1202 can store or include one or more machine-learned models 1220. For example, the machine-learned models 1220 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 1220 can be received from the server computing system 1230 over network 1280, stored in the user computing device memory 1214, and then used or otherwise implemented by the one or more processors 1212. In some implementations, the user computing system 1202 can implement multiple parallel instances of a single machine-learned model 1220 (e.g., to perform parallel machine-learned model processing across multiple instances of input data and/or detected features).

More particularly, the one or more machine-learned models 1220 may include one or more detection models, one or more classification models, one or more segmentation models, one or more augmentation models, one or more generative models, one or more natural language processing models, one or more optical character recognition models, and/or one or more other machine-learned models. The one or more machine-learned models 1220 can include one or more transformer models. The one or more machine-learned models 1220 may include one or more neural radiance field models, one or more diffusion models, and/or one or more autoregressive language models.

The one or more machine-learned models 1220 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 1220 can process image data, text data, audio data, and/or latent encoding data to generate output data that can include image data, text data, audio data, and/or latent encoding data. The one or more machine-learned models 1220 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, arXiv:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 1240 can be included in or otherwise stored and implemented by the server computing system 1230 that communicates with the user computing system 1202 according to a client-server relationship. For example, the machine-learned models 1240 can be implemented by the server computing system 1230 as a portion of a web service (e.g., a viewfinder service, a visual search service, an image processing service, an ambient computing service, and/or an overlay application service). Thus, one or more models 1220 can be stored and implemented at the user computing system 1202 and/or one or more models 1240 can be stored and implemented at the server computing system 1230.

The user computing system 1202 can also include one or more user input components 1222 that receives user input. For example, the user input component 1222 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 1202 can store and/or provide one or more user interfaces 1224, which may be associated with one or more applications. The one or more user interfaces 1224 can be configured to receive inputs and/or provide data for display (e.g., image data, text data, audio data, one or more user interface elements, an augmented-reality experience, a virtual reality experience, and/or other data for display. The user interfaces 1224 may be associated with one or more other computing systems (e.g., server computing system 1230 and/or third party computing system 1250). The user interfaces 1224 can include a viewfinder interface, a search interface, a generative model interface, a social media interface, and/or a media content gallery interface.

The user computing system 1202 may include and/or receive data from one or more sensors 1226. The one or more sensors 1226 may be housed in a housing component that houses the one or more processors 1212, the memory 1214, and/or one or more hardware components, which may store, and/or cause to perform, one or more software packets. The one or more sensors 1226 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user’s environment (e.g., an image of a user’s environment, a recording of the environment, and/or the location of the user).

The user computing system 1202 may include, and/or be part of, a user computing device 1204. The user computing device 1204 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 1204. For example, a camera of a smartphone may be utilized to capture image data descriptive of the environment, and/or an overlay application of the user computing device 1204 can be utilized to track and/or process the data being provided to the user. Similarly, one or more sensors associated with a smart wearable may be utilized to obtain data about a user and/or about a user’s environment (e.g., image data can be obtained with a camera housed in a user’s smart glasses). Additionally and/or alternatively, the data may be obtained and uploaded from other user devices that may be specialized for data obtainment or generation.

The server computing system 1230 includes one or more processors 1232 and a memory 1234. The one or more processors 1232 can be any suitable processing device (e.g., a processor core, a microprocessor, an ASIC, a FPGA, a controller, a microcontroller, etc.) and can be one processor or a plurality of processors that are operatively connected. The memory 1234 can include one or more non-transitory computer-readable storage mediums, such as RAM, ROM, EEPROM, EPROM, flash memory devices, magnetic disks, etc., and combinations thereof. The memory 1234 can store data 1236 and instructions 1238 which are executed by the processor 1232 to cause the server computing system 1230 to perform operations.

In some implementations, the server computing system 1230 includes or is otherwise implemented by one or more server computing devices. In instances in which the server computing system 1230 includes plural server computing devices, such server computing devices can operate according to sequential computing architectures, parallel computing architectures, or some combination thereof.

As described above, the server computing system 1230 can store or otherwise include one or more machine-learned models 1240. For example, the models 1240 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1240 are discussed with reference to FIG. 12B.

Additionally and/or alternatively, the server computing system 1230 can include and/or be communicatively connected with a search engine 1242 that may be utilized to crawl one or more databases (and/or resources). The search engine 1242 can process data from the user computing system 1202, the server computing system 1230, and/or the third party computing system 1250 to determine one or more search results associated with the input data. The search engine 1242 may perform term based search, label based search, Boolean based searches, image search, embedding based search (e.g., nearest neighbor search), multimodal search, and/or one or more other search techniques.

The server computing system 1230 may store and/or provide one or more user interfaces 1244 for obtaining input data and/or providing output data to one or more users. The one or more user interfaces 1244 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 1202 and/or the server computing system 1230 can train the models 1220 and/or 1240 via interaction with the third party computing system 1250 that is communicatively coupled over the network 1280. The third party computing system 1250 can be separate from the server computing system 1230 or can be a portion of the server computing system 1230. Alternatively and/or additionally, the third party computing system 1250 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model’s performance on that runtime instance (e.g., online training/learning). Example data types for the training instance and various tasks associated therewith are described throughout the present disclosure.

In some implementations, the computing system 1200 may utilize one or more soft prompts for conditioning the one or more machine-learned models (1220 and/or 1240) for downstream tasks. The one or more soft prompts can include a set of tunable parameters that can be trained (or tuned) as the parameters of the one or more machine-learned models (920 and/or 1240) are fixed. The one or more soft prompts 1224 can be trained for a specific task and/or a specific set of tasks. Alternatively and/or additionally, the one or more soft prompts 1224 may be trained to condition the one or more machine-learned models (1220 and/or 1240) to perform inferences for a particular individual, one or more entities, and/or one or more tasks such that the output is tailored for that particular individual, particular entities, and/or particular task. The one or more soft prompts 1224 can be obtained and processed with one or more inputs by the one or more machine-learned models (1220 and/or 1240).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 1200 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 1202 and/or the server computing system 1230 may store one or more soft prompts associated with the particular user and/or particular task. The soft prompt(s) can include a set of parameters. The user computing system 1202 and/or the server computing system 1230 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 1230 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 1250 can include one or more processors 1252 and a memory 1254. The one or more processors 1252 can be any suitable processing device (e.g., a processor core, a microprocessor, an ASIC, a FPGA, a controller, a microcontroller, etc.) and can be one processor or a plurality of processors that are operatively connected. The memory 1254 can include one or more non-transitory computer-readable storage mediums, such as RAM, ROM, EEPROM, EPROM, flash memory devices, magnetic disks, etc., and combinations thereof. The memory 1254 can store data 1256 and instructions 1258 which are executed by the processor 1252 to cause the third party computing system 1250 to perform operations. In some implementations, the third party computing system 1250 includes or is otherwise implemented by one or more server computing devices.

The network 1280 can be any type of communications network, such as a local area network (e.g., intranet), wide area network (e.g., Internet), or some combination thereof and can include any number of wired or wireless links. In general, communication over the network 1280 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 1220 and/or 1240) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 1202 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 1200.

The central intelligence layer can communicate with a central device data layer. The central device data layer can be a centralized repository of data for the computing system 1200. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 12B depicts a block diagram of an example computing system 150 that performs visual description processing according to example embodiments of the present disclosure. In particular, the example computing system 150 can include one or more computing devices 152 that can be utilized to obtain, and/or generate, one or more datasets that can be processed by a sensor processing system 160 and/or an output determination system 180 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 152 (e.g., one or more sensors in the computing device 152). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 152 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 160. The sensor processing system 160 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 162, which may determine a context associated with one or more content items. The context determination block 162 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 160 may include an image preprocessing block 164. The image preprocessing block 164 may be utilized to adjust one or more values of an obtained and/or received image to prepare the image to be processed by one or more machine-learned models and/or one or more search engines 174. The image preprocessing block 164 may resize the image, adjust saturation values, adjust resolution, strip and/or add metadata, and/or perform one or more other operations.

In some implementations, the sensor processing system 160 can include one or more machine-learned models, which may include a detection model 166, a segmentation model 168, a classification model 170, an embedding model 172, and/or one or more other machine-learned models. For example, the sensor processing system 160 may include one or more detection models 166 that can be utilized to detect particular features in the processed dataset. In particular, one or more images can be processed with the one or more detection models 166 to generate one or more bounding boxes associated with detected features in the one or more images.

Additionally and/or alternatively, one or more segmentation models 168 can be utilized to segment one or more portions of the dataset from the one or more datasets. For example, the one or more segmentation models 168 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 170 can be utilized to process image data, text data, audio data, latent encoding data, multimodal data, and/or other data to generate one or more classifications. The one or more classification models 170 can include one or more image classification models, one or more object classification models, one or more text classification models, one or more audio classification models, and/or one or more other classification models. The one or more classification models 170 can process data to determine one or more classifications.

In some implementations, data may be processed with one or more embedding models 172 to generate one or more embeddings. For example, one or more images can be processed with the one or more embedding models 172 to generate one or more image embeddings in an embedding space. The one or more image embeddings may be associated with one or more image features of the one or more images. In some implementations, the one or more embedding models 172 may be configured to process multimodal data to generate multimodal embeddings. The one or more embeddings can be utilized for classification, search, and/or learning embedding space distributions.

The sensor processing system 160 may include one or more search engines 174 that can be utilized to perform one or more searches. The one or more search engines 174 may crawl one or more databases (e.g., one or more local databases, one or more global databases, one or more private databases, one or more public databases, one or more specialized databases, and/or one or more general databases) to determine one or more search results. The one or more search engines 174 may perform feature matching, text based search, embedding based search (e.g., k-nearest neighbor search), metadata based search, multimodal search, web resource search, image search, text search, and/or application search.

Additionally and/or alternatively, the sensor processing system 160 may include one or more multimodal processing blocks 176, which can be utilized to aid in the processing of multimodal data. The one or more multimodal processing blocks 176 may include generating a multimodal query and/or a multimodal embedding to be processed by one or more machine-learned models and/or one or more search engines 174.

The output(s) of the sensor processing system 160 can then be processed with an output determination system 180 to determine one or more outputs to provide to a user. The output determination system 180 may include heuristic based determinations, machine-learned model based determinations, user selection based determinations, and/or context based determinations.

The output determination system 180 may determine how and/or where to provide the one or more search results in a search results interface 182. Additionally and/or alternatively, the output determination system 180 may determine how and/or where to provide the one or more machine-learned model outputs in a machine-learned model output interface 184. In some implementations, the one or more search results and/or the one or more machine-learned model outputs may be provided for display via one or more user interface elements. The one or more user interface elements may be overlaid over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 160 may be utilized to generate and/or provide an augmented-reality experience and/or a virtual-reality experience 186. For example, the one or more obtained datasets may be processed to generate one or more augmented-reality rendering assets and/or one or more virtual-reality rendering assets, which can then be utilized to provide an augmented-reality experience and/or a virtual-reality experience 186 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 188 may be determined based on the output(s) of the sensor processing system 160. For example, a search prompt, a purchase prompt, a generate prompt, a reservation prompt, a call prompt, a redirect prompt, and/or one or more other prompts may be determined to be associated with the output(s) of the sensor processing system 160. The one or more action prompts 188 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 160 may be processed with one or more generative models 190 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 190 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 190 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 190 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 190 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 190 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 190 may be stored on-device and/or may be stored on a server computing system. In some implementations, the one or more generative models 190 can perform on-device processing to determine suggested searches, suggested actions, and/or suggested prompts. The one or more generative models 190 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 190 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

The output determination system 180 may process the one or more datasets and/or the output(s) of the sensor processing system 160 with a data augmentation block 192 to generate augmented data. For example, one or more images can be processed with the data augmentation block 192 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 160 may be stored based on a data storage block 194 determination.

The output(s) of the output determination system 180 can then be provided to a user via one or more output components of the user computing device 152. For example, one or more user interface elements associated with the one or more outputs can be provided for display via a visual display of the user computing device 152.

The processes may be performed iteratively and/or continuously. One or more user inputs to the provided user interface elements may condition and/or affect successive processing loops.

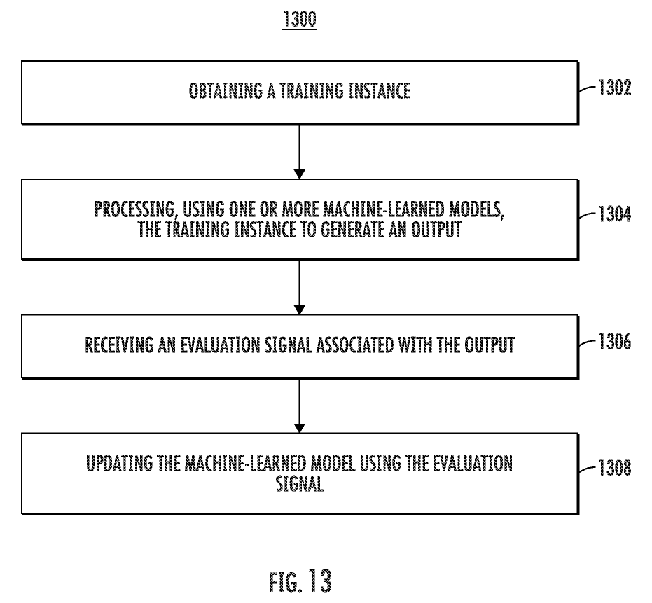

FIG. 13 depicts a flowchart of a method 1300 for training one or more machine-learned models according to aspects of the present disclosure. For instance, an example machine-learned model can include a generative agent model, a vision language model, an image captioning model, an encoder model, an embedding model, a generative language model, and/or other machine-learned model.

One or more portion(s) of example method 1300 can be implemented by a computing system that includes one or more computing devices such as, for example, computing systems described with reference to the other figures. Each respective portion of example method 1300 can be performed by any (or any combination) of one or more computing devices. Moreover, one or more portion(s) of example method 1300 can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of example method 1300 can be performed additionally, or alternatively, by other systems.

At 1302, example method 1300 can include obtaining a training instance. A set of training data can include a plurality of training instances divided between multiple datasets (e.g., a training dataset, a validation dataset, or testing dataset). A training instance can be labeled or unlabeled. Although referred to in example method 1300 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 1304, example method 1300 can include processing, using one or more machine-learned models, the training instance to generate an output. The output can be directly obtained from the one or more machine-learned models or can be a downstream result of a chain of processing operations that includes an output of the one or more machine-learned models.

At 1306, example method 1300 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1308, example method 1300 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1300 can include implementing a number of generalization techniques (e.g., weight decays, dropouts, etc.) to improve the generalization capability of the models being trained.

In some implementations, example method 1300 can be implemented for training a machine-learned model from an initialized state to a fully trained state (e.g., when the model exhibits a desired performance profile, such as based on accuracy, precision, recall, etc.).

In some implementations, example method 1300 can be implemented for particular stages of a training procedure. For instance, in some implementations, example method 1300 can be implemented for pre-training a machine-learned model. Pre-training can include, for instance, large-scale training over potentially noisy data to achieve a broad base of performance levels across a variety of tasks/data types. In some implementations, example method 1300 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

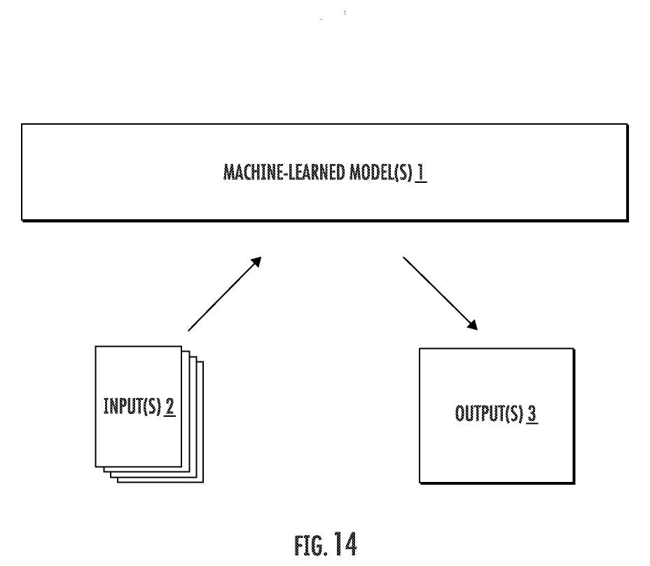

FIG. 14 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

FIG. 15 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.), Georgiev et al., “Gemini 1.5: Unlocking multimodal understanding across millions of tokens of context,” arXiv (Dec. 16, 2024), https://arxiv.org/abs/2403.05530., “Introducing Gemini 2.0: our new AI model for the agentic era,” Google (Dec. 11, 2024), https://blog.google/technology/google-deepmind/google-gemini-ai-update-december-2024/#ceo-message., and Riviere et al., “Gemma 2: Improving Open Language Models at a Practical Size,” arXiv (Oct. 2, 2024), https://arxiv.org/abs/2408.00118. Other example sequence processing models can operate in other domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 15 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

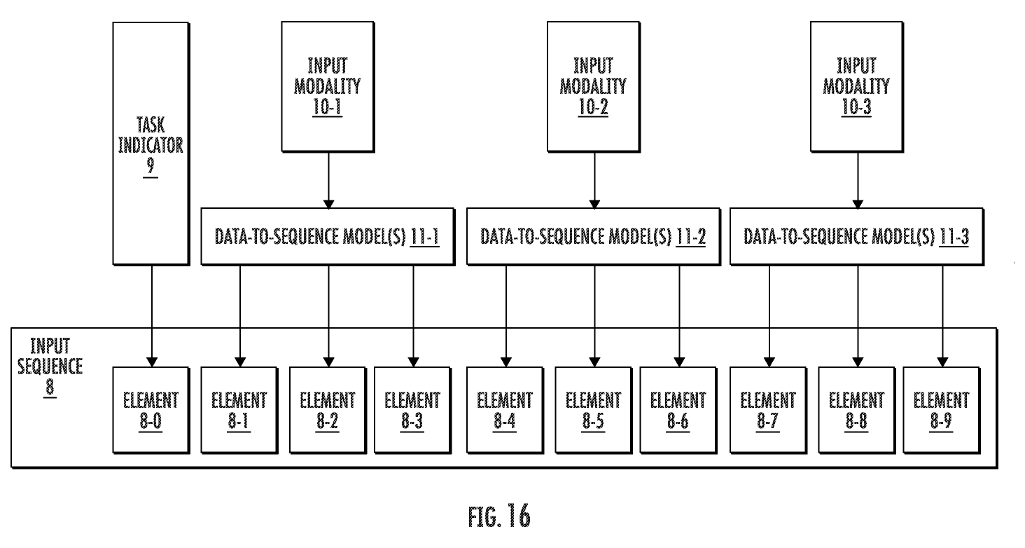

FIG. 16 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned embedding within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

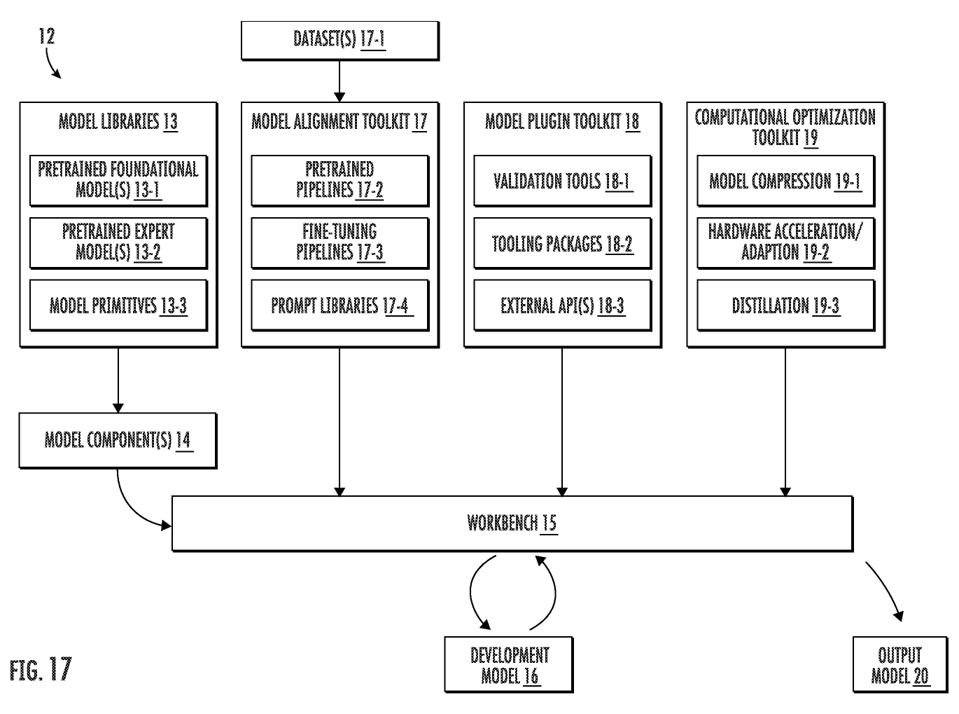

FIG. 17 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output and an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

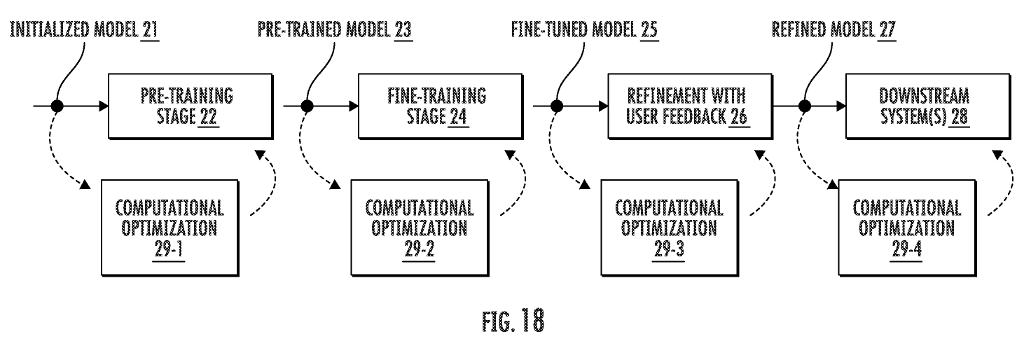

FIG. 18 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 18 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 18 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

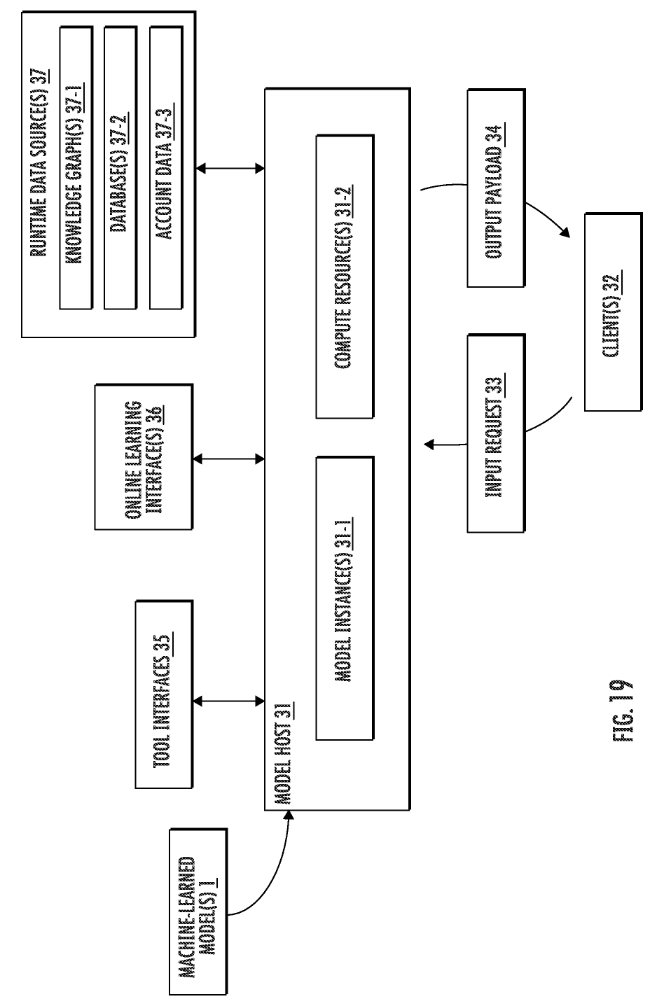

FIG. 19 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

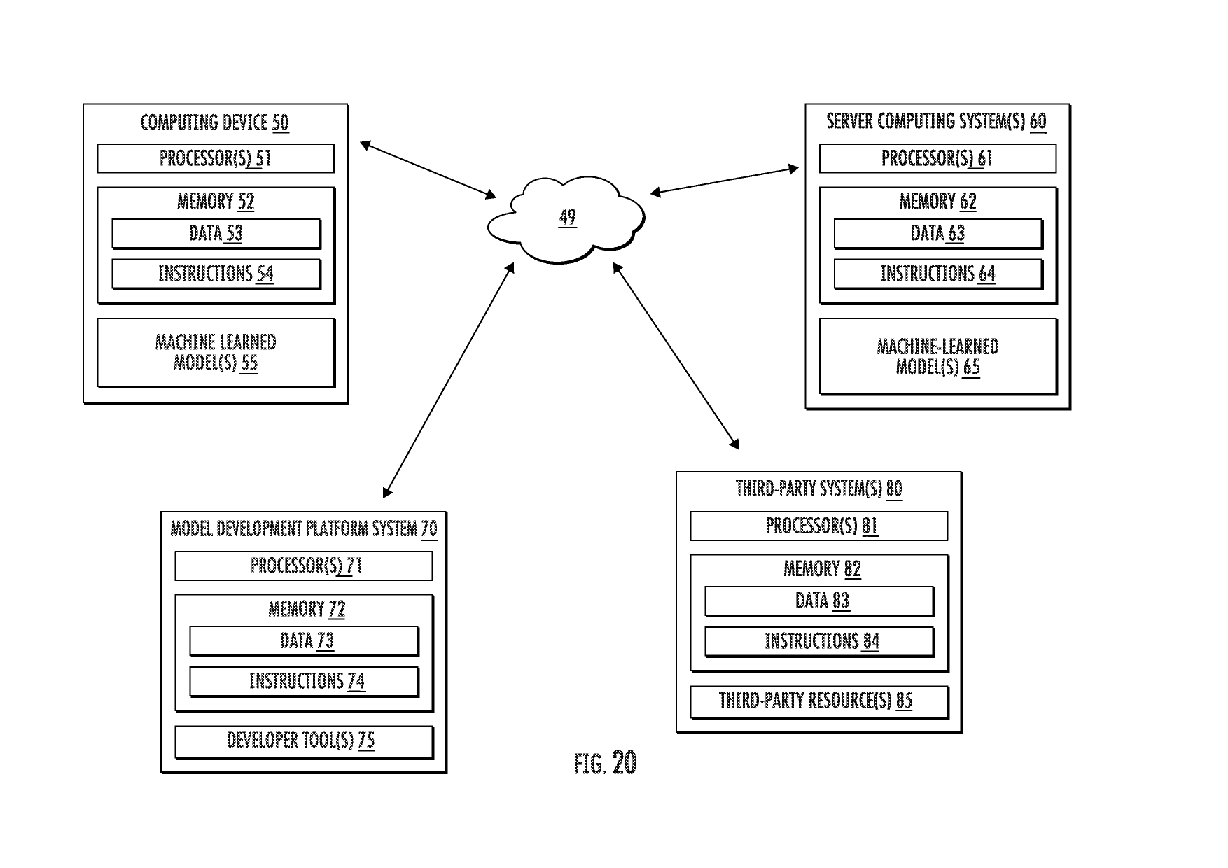

FIG. 20 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 20 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 20 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

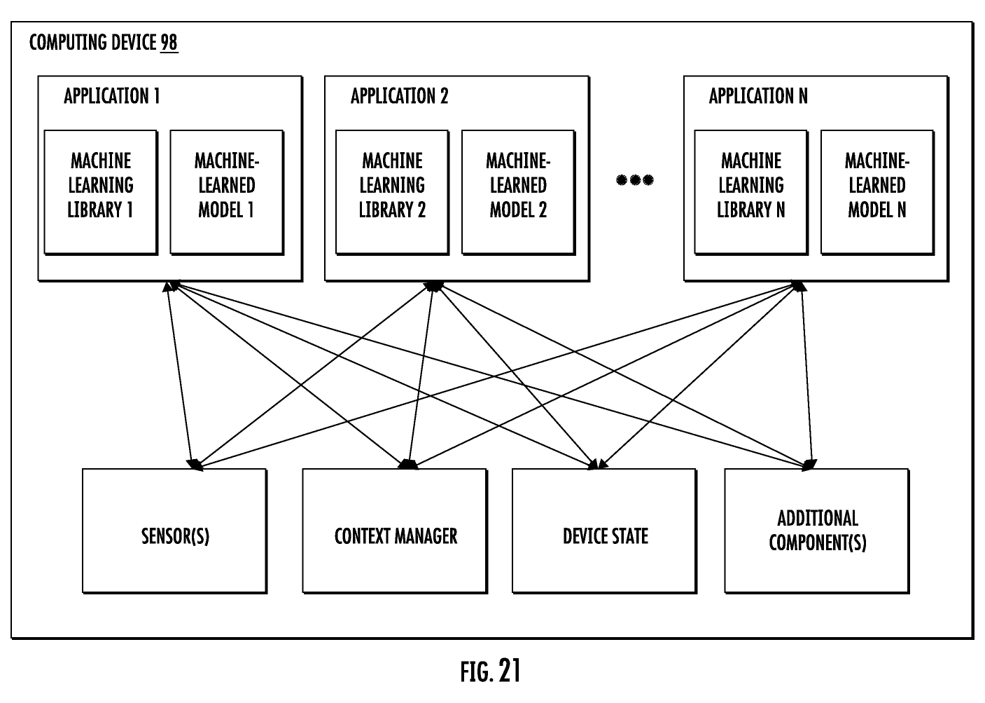

FIG. 21 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 21, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

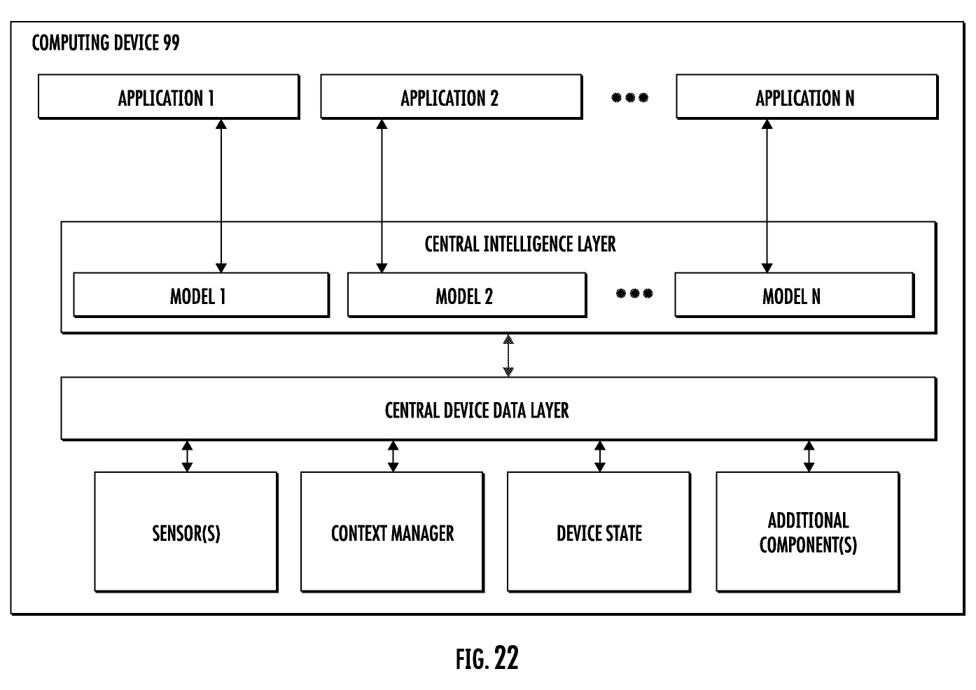

FIG. 22 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 22, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 22, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, the method comprising:
obtaining, by a computing system comprising one or more processors, file data associated with a particular file, wherein the particular file comprises multimodal data;
processing, by the computing system, the file data with a generative agent model to generate a plurality of different visual description outputs, wherein the generative agent model interfaces with a plurality of different data processing tools to generate the plurality of different visual description outputs;
storing, by the computing system, the file data with the plurality of different visual description outputs; and
training, by the computing system, a vision language model on a training example comprising the file data and one or more of the plurality of different visual description outputs, wherein training the vision language model comprises training the vision language model to perform semantic understanding of the multimodal data via training the vision language model to generate an intermediate representation that is evaluated based on a comparison with the one or more of the plurality of different visual description outputs.

2. The method of claim 1, wherein the plurality of different visual description outputs comprises a hierarchical tree of semantic elements, wherein the hierarchical tree of semantic elements is descriptive of features depicted in the particular file.

3. The method of claim 1, wherein processing, by the computing system, the generative agent model to generate the plurality of different visual description outputs comprises:
processing, by the computing system, the file data with a first data processing tool to de-render an image from the particular file.

4. The method of claim 1, wherein processing, by the computing system, the generative agent model to generate the plurality of different visual description outputs comprises:
processing, by the computing system, the file data with an image annotation model to generate an annotated document, wherein the annotated document comprises a plurality of annotations rendered within the particular file.

5. The method of claim 1, wherein processing, by the computing system, the generative agent model to generate the plurality of different visual description outputs comprises:
processing, by the computing system, the file data with a second data processing tool to generate a second coding language output, wherein the second coding language output is descriptive of code for rendering the particular file, wherein the second coding language output differs from a coding language of the file data.

6. The method of claim 1, wherein the plurality of different visual description outputs comprises:
a first output comprising a list of elements depicted in the particular file;
a second output is descriptive of relative location information for a plurality of elements depicted in the particular file; and
a third output comprising code for rendering the particular file.

7. The method of claim 1, wherein the plurality of different visual description outputs comprises:
a scalable vector graphics output comprising a vector image format description of at least a subset of the particular file; and
a hypertext markup language format output comprising a hypertext markup language format description of the at least a subset of the particular file.

8. The method of claim 1, wherein the intermediate representation comprises an organized hierarchical representation of the plurality of different visual description outputs in a natural language format that is configured to be processed with one or more prediction blocks of the vision language model to perform one or more downstream tasks.

9. The method of claim 1, wherein the particular file comprises a document in a native document markup format.

10. The method of claim 1, wherein the vision language model is trained to perform image captioning based on the file data and the plurality of different visual description outputs.

11. A computing system for multimodal document processing, the system comprising:
one or more processors; and
one or more non-transitory computer-readable media that collectively store instructions that, when executed by the one or more processors, cause the computing system to perform operations, the operations comprising:
obtaining a multimodal document, wherein the multimodal document comprises an image and structured text;
processing the multimodal document with a generative agent model to generate an aggregated dataset descriptive of a plurality of different visual description outputs, wherein generating the plurality of different visual description outputs comprises:
processing the multimodal document to generate a first output descriptive of a list of a plurality of elements depicted in the multimodal document;
processing the multimodal document to generate a second output comprising element relationship information descriptive model determined semantic relationships between the plurality of elements depicted in the multimodal document; and
processing the multimodal document to generate a third output comprising code for recreating at least a portion of the multimodal document;
processing the aggregated dataset and a prompt with a generative language model to generate a model-generated output, wherein the model-generated output comprises a response generated based on the plurality of different visual description outputs; and
providing the model-generated output for display.

12. The system of claim 11, wherein the prompt is descriptive of a request for a particular downstream task to be performed on the multimodal document.

13. The system of claim 12, wherein the particular downstream task comprises document augmentation.

14. The system of claim 12, wherein the particular downstream task comprises generating an output descriptive of a semantic understanding of the multimodal document.

15. The system of claim 11, wherein the first output is generated with a first model, wherein the second output is generated with a second model, and wherein the third output is generated with a third model.

16. The system of claim 15, wherein the first model, the second model, and the third model are external to the generative agent model, and wherein the aggregated dataset is generated by the generative agent model interfacing with each of the first model, the second model, and the third model.

17. One or more non-transitory computer-readable media that collectively store instructions that, when executed by one or more computing devices, cause the one or more computing devices to perform operations, the operations comprising:
obtaining a particular file, wherein the particular file comprises an image and structured text;
processing the particular file with a generative agent model to generate an aggregated dataset descriptive of a plurality of different visual description outputs, wherein the aggregated dataset comprises a hierarchical tree of information associated with the particular file, wherein the plurality of different visual description outputs comprises a first description of a first level of granularity, a second description of a second level of granularity, and a third description descriptive of code for re-rendering the particular file;
processing at least a portion of the aggregated dataset and a prompt with a generative language model to generate a model-generated output, wherein the prompt comprises a query requesting information associated with the particular file, and wherein the model-generated output comprises a response generated based on one or more of the plurality of different visual description outputs; and
providing the model-generated output for display.

18. The one or more non-transitory computer-readable media of claim 17, wherein the model-generated output comprises an annotated version of the particular file, wherein the particular file is annotated to indicate relevant portions of the particular file associated with the prompt.

19. The one or more non-transitory computer-readable media of claim 17, wherein the model-generated output comprises a structured format of information responsive to the query and comprising details from the plurality of different visual description outputs.

20. The one or more non-transitory computer-readable media of claim 19, wherein the structured format comprises image data, text data, and a diagram representation.
